(19) United States
(12) Patent Application Publication
(10) Pub. No.: US 2025/0141624 A1
(43) Pub. Date: May 1, 2025

(54) SOUNDING REFERENCE SIGNAL RESOURCE INDICATOR AND TRANSMIT PRECODER MATRIX INDICATOR SIGNALING FOR UPLINK SPATIAL DIVISION MULTIPLEXING

(71) Applicant: QUALCOMM Incorporated, San Diego, CA (US)

(72) Inventors: Yitao CHEN, San Marcos, CA (US); Mostafa KHOSHNEVISAN, San Diego, CA (US); Xiaoxia ZHANG, San Diego, CA (US); Jing SUN, San Diego, CA (US); Tao LUO, San Diego, CA (US); Peter GAAL, San Diego, CA (US); Fang YUAN, Beijing (CN); Wooseok NAM, San Diego, CA (US)

(21) Appl. No.: 18/690,948

(22) PCT Filed: Dec. 1, 2021
(86) PCT No.: PCT/CN2021/134738

§ 371 Date: Mar. 11, 2024

(51) Int. Cl. H04L 5/00; H04B 7/0404; H04B 7/0456; H04B 7/06; H04W 72/21; H04W 72/232

(52) U.S. Cl. CPC H04L 5/0051; H04B 7/0404; H04B 7/0456; H04B 7/0697; H04W 72/21; H04W 72/232

(57) ABSTRACT

Various aspects of the present disclosure generally relate to wireless communication. In some aspects, a user equipment (UE) may receive configuration information associated with a first sounding reference signal (SRS) resource set and a second SRS resource set. The UE may receive downlink control information (DCI) that schedules a spatial division multiplexing (SDM) physical uplink shared channel (PUSCH) communication, the DCI including a plurality of fields associated with the SDM PUSCH communication. Numerous other aspects are provided.

### FIELD OF THE DISCLOSURE

Aspects of the present disclosure generally relate to wireless communication and specifically, to techniques and apparatuses for sounding reference signal (SRS) resource indicator (SRI) signaling and transmit precoder matrix indicator (TPMI) signaling for spatial division multiplexing (SDM).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

A UE may be configured to transmit a physical uplink shared channel (PUSCH) communication using spatial division multiplexing (SDM). For SDM of a PUSCH communication, different sets of layers may have different transmission parameters (for example, different beams, different sets of power control parameters), different precoding parameters (for example, different quantities of layers, different transmit precoder matrix indicators (TPMIs)), or a combination thereof. For example, a first set of layers may be associated with a first set of transmission parameters (such as a first beam, a first set of power control parameters, or a combination thereof) and a first set of precoding parameters (such as a first quantity of layers, a first TPMI index, or a combination thereof). A second set of layers may be associated with a second set of transmission parameters (such as a second beam, a second set of power control parameters, or a combination thereof) and a second set of precoding parameters (such as a second quantity of layers, a second TPMI index, or a combination thereof). Sounding reference signal (SRS) resource sets for the PUSCH communication may map to respective sets of parameters. For example, a first SRS resource set may map to the first set of transmission parameters and a second SRS resource set may map to the second set of transmission parameters. As another example, a first SRS resource set may map to the second set of transmission parameters and a second SRS resource set may map to the first set of transmission parameters

A UE that is scheduled to transmit a PUSCH communication using SDM may be unable to determine a length (such as a quantity of bits) of a first TPMI field, in downlink control information (DCI) that schedules the SDM PUSCH communication, associated with the first set of layers. Similarly, the UE may be unable to determine a length of a second TPMI field, in the DCI that schedules the PUSCH communication, associated with the second set of layers. As a result, the UE may be unable to interpret the first TPMI field and the second TPMI field. Thus, the UE may be unable to identify respective precoders for transmitting the SDM PUSCH communication using the first set of layers and the second set of layers.

### SUMMARY

Some aspects described herein relate to a user equipment (UE) for wireless communication. The UE may include at least one processor and at least one memory, communicatively coupled with the at least one processor, that stores processor-readable code. The processor-readable code, when executed by the at least one processor, may be configured to cause the UE to receive configuration information associated with a first sounding reference signal (SRS) resource set and a second SRS resource set. The processor-readable code, when executed by the at least one processor, may be configured to cause the UE to receive downlink control information (DCI) that schedules a spatial division multiplexing (SDM) physical uplink shared channel (PUSCH) communication, the DCI including a first SRS resource indicator (SRI) field associated with the first SRS resource set that indicates one or more first transmission parameters for one or more first layers of the SDM PUSCH communication, a first transmit precoder matrix indicator (TPMI) field that indicates one or more first precoding parameters for the one or more first layers, a second SRI field associated with the second SRS resource set that indicates a one or more second transmission parameters for one or more second layers of the SDM PUSCH communication, and a second TPMI field that indicates one or more second precoding parameters for the one or more second layers.

Some aspects described herein relate to a base station for wireless communication. The base station may include at least one processor and at least one memory, communicatively coupled with the at least one processor, that stores processor-readable code. The processor-readable code, when executed by the at least one processor, may be configured to cause the base station to transmit configuration information associated with a first SRS resource set and a second SRS resource set. The processor-readable code, when executed by the at least one processor, may be configured to cause the base station to transmit DCI that schedules an SDM PUSCH communication, the DCI including a first SRI field associated with the first SRS resource set that indicates one or more first transmission parameters for one or more first layers of the SDM PUSCH communication, a first TPMI field that indicates one or more first precoding parameters for the one or more first layers, a second SRI field associated with the second SRS resource set that indicates a one or more second transmission parameters for one or more second layers of the SDM PUSCH communication, and a second TPMI field that indicates one or more second precoding parameters for the one or more second layers.

Some aspects described herein relate to a method of wireless communication performed by a UE. The method may include receiving configuration information associated with a first SRS resource set and a second SRS resource set. The method may include receiving DCI that schedules an SDM PUSCH communication, the DCI including, a first SRI field associated with the first SRS resource set that indicates one or more first transmission parameters for one or more first layers of the SDM PUSCH communication, a first TPMI field that indicates one or more first precoding parameters for the one or more first layers, a second SRI field associated with the second SRS resource set that indicates a one or more second transmission parameters for one or more second layers of the SDM PUSCH communication, and a second TPMI field that indicates one or more second precoding parameters for the one or more second layers.

Some aspects described herein relate to a method of wireless communication performed by a base station. The method may include transmitting configuration information associated with a first SRS resource set and a second SRS resource set. The method may include transmitting DCI that schedules an SDM PUSCH communication, the DCI including, a first SRI field associated with the first SRS resource set that indicates one or more first transmission parameters for one or more first layers of the SDM PUSCH communication, a first TPMI field that indicates one or more first precoding parameters for the one or more first layers, a second SRI field associated with the second SRS resource set that indicates a one or more second transmission parameters for one or more second layers of the SDM PUSCH communication, and a second TPMI field that indicates one or more second precoding parameters for the one or more second layers.

Some aspects described herein relate to a non-transitory computer-readable medium that stores a set of instructions for wireless communication by a UE. The set of instructions, when executed by one or more processors of the UE, may cause the UE to receive configuration information associated with a first SRS resource set and a second SRS resource set. The set of instructions, when executed by one or more processors of the UE, may cause the UE to receive DCI that schedules an SDM PUSCH communication, the DCI including, a first SRI field associated with the first SRS resource set that indicates one or more first transmission parameters for one or more first layers of the SDM PUSCH communication, a first TPMI field that indicates one or more first precoding parameters for the one or more first layers, a second SRI field associated with the second SRS resource set that indicates a one or more second transmission parameters for one or more second layers of the SDM PUSCH communication, and a second TPMI field that indicates one or more second precoding parameters for the one or more second layers.

Some aspects described herein relate to a non-transitory computer-readable medium that stores a set of instructions for wireless communication by a base station. The set of instructions, when executed by one or more processors of the base station, may cause the base station to transmit configuration information associated with a first SRS resource set and a second SRS resource set. The set of instructions, when executed by one or more processors of the base station, may cause the base station to transmit DCI that schedules an SDM PUSCH communication, the DCI including, a first SRI field associated with the first SRS resource set that indicates one or more first transmission parameters for one or more first layers of the SDM PUSCH communication, a first TPMI field that indicates one or more first precoding parameters for the one or more first layers, a second SRI field associated with the second SRS resource set that indicates a one or more second transmission parameters for one or more second layers of the SDM PUSCH communication, and a second TPMI field that indicates one or more second precoding parameters for the one or more second layers.

Some aspects described herein relate to an apparatus for wireless communication. The apparatus may include means for receiving configuration information associated with a first SRS resource set and a second SRS resource set. The apparatus may include means for receiving DCI that schedules an SDM PUSCH communication, the DCI including, a first SRI field associated with the first SRS resource set that indicates one or more first transmission parameters for one or more first layers of the SDM PUSCH communication, a first TPMI field that indicates one or more first precoding parameters for the one or more first layers, a second SRI field associated with the second SRS resource set that indicates a one or more second transmission parameters for one or more second layers of the SDM PUSCH communication, and a second TPMI field that indicates one or more second precoding parameters for the one or more second layers.

Some aspects described herein relate to an apparatus for wireless communication. The apparatus may include means for transmitting configuration information associated with a first SRS resource set and a second SRS resource set. The apparatus may include means for transmitting DCI that schedules an SDM PUSCH communication, the DCI including, a first SRI field associated with the first SRS resource set that indicates one or more first transmission parameters for one or more first layers of the SDM PUSCH communication, a first TPMI field that indicates one or more first precoding parameters for the one or more first layers, a second SRI field associated with the second SRS resource set that indicates a one or more second transmission parameters for one or more second layers of the SDM PUSCH communication, and a second TPMI field that indicates one or more second precoding parameters for the one or more second layers.

Aspects generally include a method, apparatus, system, computer program product, non-transitory computer-readable medium, user equipment, base station, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example of a base station in communication with a user equipment (UE) in a wireless network in accordance with the present disclosure.

FIG. 3 illustrates an example logical architecture of a distributed radio access network (RAN), in accordance with the present disclosure.

FIG. 4 is a diagram illustrating an example of multiple transmit receive point (TRP) communication, in accordance with the present disclosure.

FIG. 5 is a diagram illustrating an example of sounding reference signal (SRS) resource sets, in accordance with the present disclosure.

FIG. 6 is a diagram illustrating an example of dynamic switching between single-TRP (sTRP) communications and multiple-TRP (mTRP) communications, in accordance with the present disclosure.

FIGS. 7-9 are diagrams illustrating examples associated with SRS resource indicator (SRI) signaling and transmit precoder matrix indicator (TPMI) signaling for spatial division multiplexing (SDM), in accordance with the present disclosure.

FIGS. 10 and 11 are diagrams illustrating example processes associated with SRI signaling and TPMI signaling for SDM, in accordance with the present disclosure.

FIGS. 12 and 13 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to sounding reference signal (SRS) resource indicator (SRI) signaling and transmit precoder matrix indicator (TPMI) signaling for spatial division multiplexing (SDM). Some aspects more specifically relate to including, in downlink control information (DCI) that schedules a physical uplink shared channel (PUSCH) communication, a plurality of fields associated with the PUSCH communication that are configured to indicate transmission parameters and precoding parameters for a plurality of layers (spatial layers) of the PUSCH communication for SDM. In some aspects, a user equipment (UE) may use one or more techniques to interpret the first TPMI field and the second TPMI field to identify precoders for the plurality of layers of the PUSCH communication. In some aspects, the DCI is configured to further include a dynamic switching indicator for switching between single transmit receive point (sTRP) transmission of the SDM PUSCH communication and multiple transmit receive point (mTRP) transmission of the SDM PUSCH communication. In some aspects, the UE is configured to use one or more techniques to interpret the first TPMI field and the second TPMI field based at least in part on the dynamic switching indicator to support SDM for sTRP transmission and mTRP transmission.

Particular aspects of the subject matter described in this disclosure can be implemented to realize one or more of the following potential advantages. In some examples, the described techniques can be used to enable the UE to transmit the PUSCH communication using different transmission parameters for different subsets of the plurality of layers, using different precoding parameters for different subsets of the plurality of layers, or a combination thereof, which increases the flexibility and configurability of SDM for PUSCH. In some examples, the described techniques can be used to enable the UE to dynamically switch between sTRP transmission of PUSCH communications and mTRP transmission of PUSCH communications.

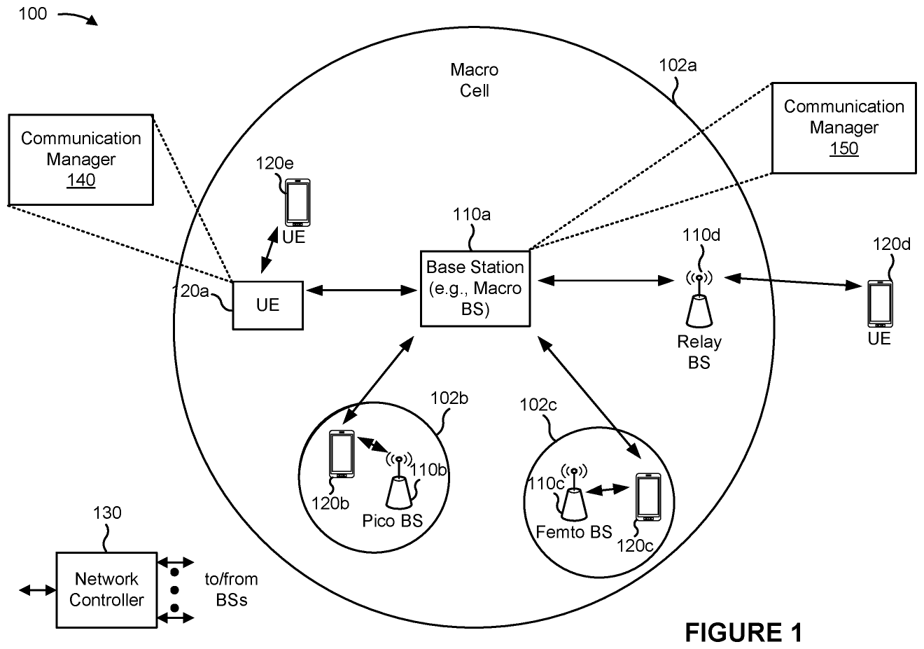

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more base stations 110 (shown as a BS 110a, a BS 110b, a BS 110c, and a BS 110d), a UE 120 or multiple UEs 120 (shown as a UE 120a, a UE 120b, a UE 120c, a UE 120d, and a UE 120e), or other network entities. A base station 110 is an entity that communicates with UEs 120. A base station 110 (sometimes referred to as a BS) may include, for example, an NR base station, an LTE base station, a Node B, an eNB (for example, in 4G), a gNB (for example, in 5G), an access point, or a transmit receive point (TRP). Each base station 110 may provide communication coverage for a particular geographic area. In the Third Generation Partnership Project (3GPP), the term “cell” can refer to a coverage area of a base station 110 or a base station subsystem serving this coverage area, depending on the context in which the term is used.

A base station 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station.

The wireless network 100 may be a heterogeneous network that includes base stations 110 of different types, such as macro base stations, pico base stations, femto base stations, or relay base stations. These different types of base stations 110 may have different transmit power levels, different coverage areas, or different impacts on interference in the wireless network 100. For example, macro base stations may have a high transmit power level (for example, 5 to 40 watts) whereas pico base stations, femto base stations, and relay base stations may have lower transmit power levels (for example, 0.1 to 2 watts). In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (for example, three) cells. A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

In some examples, a cell may not necessarily be stationary, and the geographic area of the cell may move in accordance with the location of a base station 110 that is mobile (for example, a mobile base station). In some examples, the base stations 110 may be interconnected to one another or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a base station 110 or a UE 120) and send a transmission of the data to a downstream station (for example, a UE 120 or a base station 110). A relay station may be a UE 120 that can relay transmissions for other UEs 120. In the example shown in FIG. 1, the BS 110d (for example, a relay base station) may communicate with the BS 110a (for example, a macro base station) and the UE 120d in order to facilitate communication between the BS 110a and the UE 120d. A base station 110 that relays communications may be referred to as a relay station, a relay base station, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the base station 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FRI is often referred to (interchangeably) as a “Sub-6 GHZ” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FRI or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHz,” if used herein, may broadly represent frequencies that may be less than 6 GHZ, may be within FR1, or may include mid-band frequencies. Further, unless specifically stated otherwise, it should be understood that the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive configuration information associated with a first sounding reference signal (SRS) resource set and a second SRS resource set, may receive DCI that schedules an SDM PUSCH communication, the DCI including a first SRS resource indicator (SRI) field associated with the first SRS resource set that indicates one or more first transmission parameters for one or more first layers of the SDM PUSCH communication, a first TPMI field that indicates one or more first precoding parameters for the one or more first layers, a second SRI field associated with the second SRS resource set that indicates a one or more second transmission parameters for one or more second layers of the SDM PUSCH communication, and a second TPMI field that indicates one or more second precoding parameters for the one or more second layers, or a combination thereof. Additionally, or alternatively, the communication manager 140 may perform one or more other operations described herein.

In some aspects, the base station 110 may include a communication manager 150. As described in more detail elsewhere herein, the communication manager 150 may transmit configuration information associated with a first SRS resource set and a second SRS resource set, may transmit DCI that schedules an SDM PUSCH communication, the DCI including a first SRI field associated with the first SRS resource set that indicates one or more first transmission parameters for one or more first layers of the SDM PUSCH communication, a first TPMI field indicating one or more first precoding parameters for the one or more first layers, a second SRI field associated with the second SRS resource set that indicates one or more second transmission parameters for one or more second layers of the SDM PUSCH communication, and a second TPMI field indicating one or more second precoding parameters for the one or second more layers, or a combination thereof. Additionally, or alternatively, the communication manager 150 may perform one or more other operations described herein.

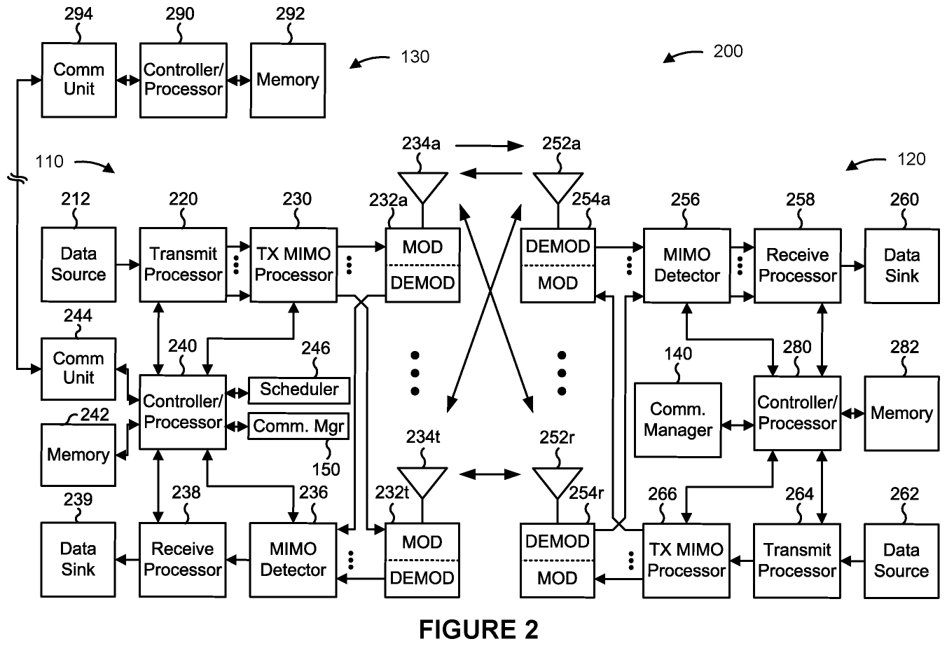

FIG. 2 is a diagram illustrating an example 200 of a base station in communication with a UE in a wireless network in accordance with the present disclosure. The base station may correspond to the base station 110 of FIG. 1. Similarly, the UE may correspond to the UE 120 of FIG. 1. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the base station 110 or other base stations 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the base station 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

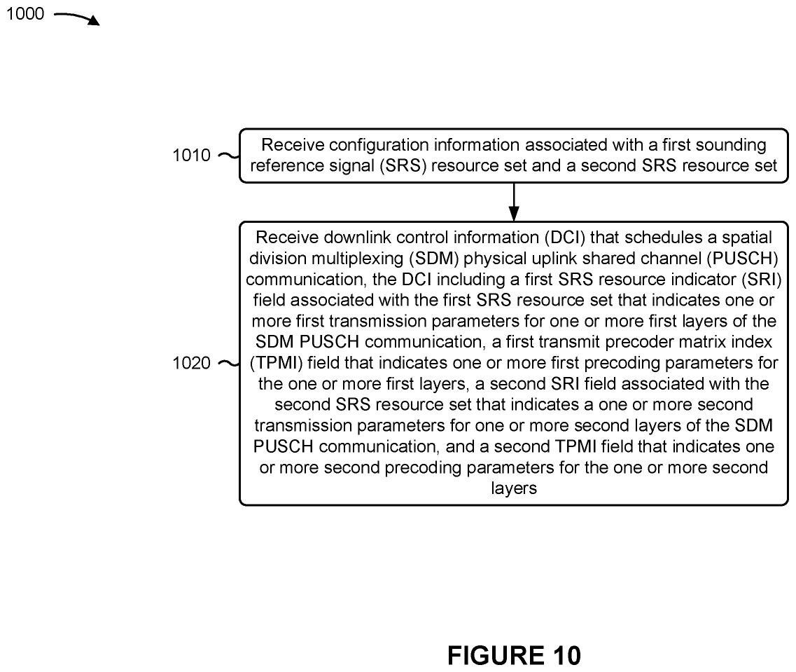

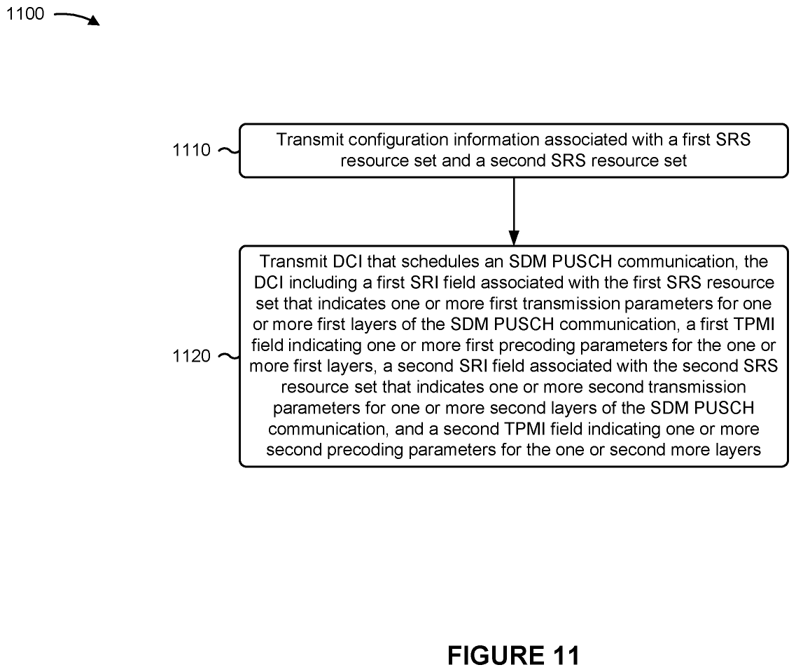

The controller/processor 240 of the base station 110, the controller/processor 280 of the UE 120, or any other component(s) of FIG. 2 may perform one or more techniques associated with SRI signaling and TPMI signaling for SDM, as described in more detail elsewhere herein. For example, the controller/processor 240 of the base station 110, the controller/processor 280 of the UE 120, or any other component(s) of FIG. 2 may perform or direct operations of, for example, process 1000 of FIG. 10, process 1100 of FIG. 11, or other processes as described herein. The memory 242 and the memory 282 may store data and program codes for the base station 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the base station 110 or the UE 120, may cause the one or more processors, the UE 120, or the base station 110 to perform or direct operations of, for example, process 1000 of FIG. 10, process 1100 of FIG. 11, or other processes as described herein. In some examples, executing instructions may include running the instructions, converting the instructions, compiling the instructions, or interpreting the instructions, among other examples.

In some aspects, the UE 120 includes means for receiving configuration information associated with a first SRS resource set and a second SRS resource set, means for receiving DCI that schedules an SDM PUSCH communication, the DCI including a first SRI field associated with the first SRS resource set that indicates one or more first transmission parameters for one or more first layers of the SDM PUSCH communication, a first TPMI field that indicates one or more first precoding parameters for the one or more first layers, a second SRI field associated with the second SRS resource set that indicates a one or more second transmission parameters for one or more second layers of the SDM PUSCH communication, and a second TPMI field that indicates one or more second precoding parameters for the one or more second layers, or a combination thereof. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes 110 means for transmitting configuration information associated with a first SRS resource set and a second SRS resource set, means for transmitting DCI that schedules an SDM PUSCH communication, the DCI including a first SRI field associated with the first SRS resource set that indicates one or more first transmission parameters for one or more first layers of the SDM PUSCH communication, a first TPMI field indicating one or more first precoding parameters for the one or more first layers, a second SRI field associated with the second SRS resource set that indicates one or more second transmission parameters for one or more second layers of the SDM PUSCH communication, and a second TPMI field indicating one or more second precoding parameters for the one or second more layers, or a combination thereof. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

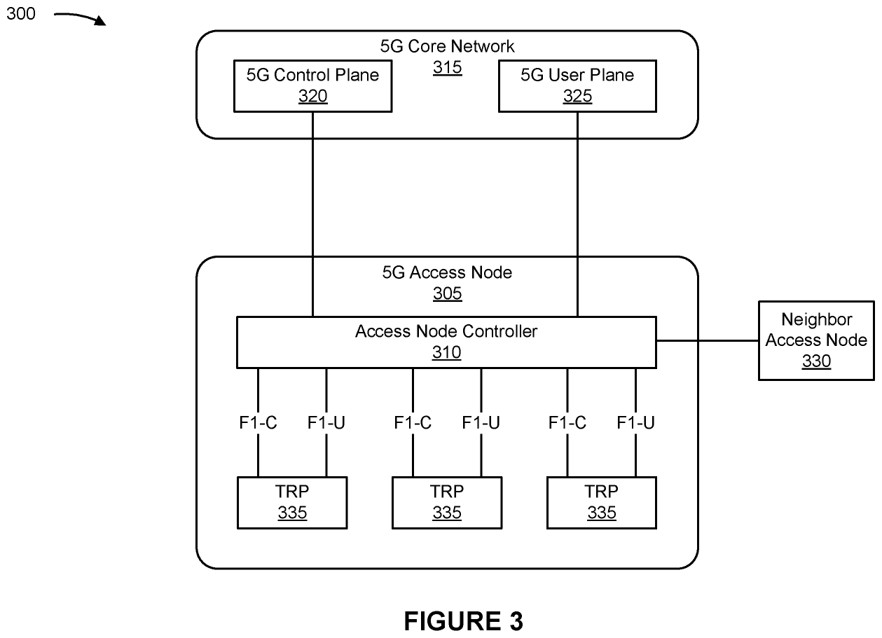

FIG. 3 illustrates an example logical architecture of a distributed radio access network (RAN) 300, in accordance with the present disclosure.

A 5G access node 305 may include an access node controller 310. The access node controller 310 may be a central unit (CU) of the distributed RAN 300. In some examples, a backhaul interface to a 5G core network 315 may terminate at the access node controller 310. The 5G core network 315 may include a 5G control plane component 320 and a 5G user plane component 325 (for example, a 5G gateway), and the backhaul interface for one or both of the 5G control plane and the 5G user plane may terminate at the access node controller 310. Additionally, or alternatively, a backhaul interface to one or more neighbor access nodes 330 (for example, another 5G access node 305 or an LTE access node) may terminate at the access node controller 310.

The access node controller 310 may include or may communicate with one or more TRPs 335 (for example, via an F1 Control (F1-C) interface or an F1 User (F1-U) interface). A TRP 335 may be a distributed unit (DU) of the distributed RAN 300. In some examples, a TRP 335 may correspond to a base station 110 described above in connection with FIG. 1. For example, different TRPs 335 may be included in different base stations 110. Additionally, or alternatively, multiple TRPs 335 may be included in a single base station 110. In some examples, a base station 110 may include a CU (for example, access node controller 310) or one or more DUs (for example, one or more TRPs 335). In some cases, a TRP 335 may be referred to as a cell, a panel, an antenna array, or an array.

A TRP 335 may be connected to a single access node controller 310 or to multiple access node controllers 310. In some examples, a dynamic configuration of split logical functions may be present within the architecture of distributed RAN 300. For example, a packet data convergence protocol (PDCP) layer, a radio link control (RLC) layer, or a medium access control (MAC) layer may be configured to terminate at the access node controller 310 or at a TRP 335.

In some examples, multiple TRPs 335 may transmit communications (for example, the same communication or different communications) in the same transmission time interval (TTI) (for example, a slot, a mini-slot, a subframe, or a symbol) or different TTIs using different quasi co-location (QCL) relationships (for example, different spatial parameters, different transmission configuration indicator (TCI) states, different precoding parameters, or different beamforming parameters). In some examples, a TCI state may be used to indicate one or more QCL relationships. A TRP 335 may be configured to individually (for example, using dynamic selection) or jointly (for example, using joint transmission with one or more other TRPs 335) serve traffic to a UE 120.

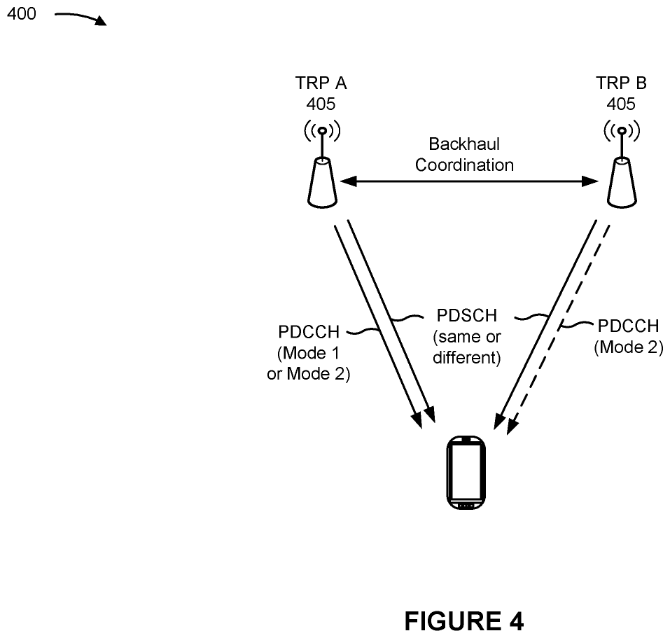

FIG. 4 is a diagram illustrating an example 400 of multi-TRP communication, in accordance with the present disclosure. Multi-TRP communication may sometimes referred to as multi-panel communication. As shown in FIG. 4, multiple TRPs 405 may communicate with the same UE 120. A TRP 405 may correspond to a TRP 335 described above in connection with FIG. 3.

The multiple TRPs 405 (shown as TRP A and TRP B) may communicate with the same UE 120 in a coordinated manner (for example, using coordinated multipoint transmissions) to improve reliability or increase throughput. The TRPs 405 may coordinate such communications via an interface between the TRPs 405 (for example, a backhaul interface or an access node controller 310). The interface may have a smaller delay or higher capacity when the TRPs 405 are co-located at the same base station 110 (for example, when the TRPs 405 are different antenna arrays or panels of the same base station 110), and may have a larger delay or lower capacity (as compared to co-location) when the TRPs 405 are located at different base stations 110. The different TRPs 405 may communicate with the UE 120 using different QCL relationships (for example, different TCI states), different DMRS ports, or different layers (for example, of a multi-layer communication).

In a first multi-TRP transmission mode (for example, Mode 1), a single physical downlink control channel (PDCCH) may be used to schedule downlink data communications for a single physical downlink shared channel (PDSCH). In this case, multiple TRPs 405 (for example, TRP A and TRP B) may transmit communications to the UE 120 on the same PDSCH. For example, a communication may be transmitted using a single codeword with different spatial layers for different TRPs 405 (for example, where one codeword maps to a first set of layers transmitted by a first TRP 405 and maps to a second set of layers transmitted by a second TRP 405). As another example, a communication may be transmitted using multiple codewords, where different codewords are transmitted by different TRPs 405 (for example, using different sets of layers). In either case, different TRPs 405 may use different QCL relationships (for example, different TCI states) for different DMRS ports corresponding to different layers. For example, a first TRP 405 may use a first QCL relationship or a first TCI state for a first set of DMRS ports corresponding to a first set of layers, and a second TRP 405 may use a second (different) QCL relationship or a second (different) TCI state for a second (different) set of DMRS ports corresponding to a second (different) set of layers. In some examples, a TCI state in DCI (for example, transmitted on the PDCCH, such as DCI format 1_0 or DCI format 1_1) may indicate the first QCL relationship (for example, by indicating a first TCI state) and the second QCL relationship (for example, by indicating a second TCI state). The first TCI state and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (for example, Mode 1).

In a second multi-TRP transmission mode (for example, Mode 2), multiple PDCCHs may be used to schedule downlink data communications for multiple corresponding PDSCHs (for example, one PDCCH for each PDSCH). In this case, a first PDCCH may schedule a first codeword to be transmitted by a first TRP 405, and a second PDCCH may schedule a second codeword to be transmitted by a second TRP 405. Furthermore, first DCI (for example, transmitted by the first TRP 405) may schedule a first PDSCH communication associated with a first set of DMRS ports with a first QCL relationship (for example, indicated by a first TCI state) for the first TRP 405, and second DCI (for example, transmitted by the second TRP 405) may schedule a second PDSCH communication associated with a second set of DMRS ports with a second QCL relationship (for example, indicated by a second TCI state) for the second TRP 405. In this case, DCI (for example, having DCI format 1_0 or DCI format 1_1) may indicate a corresponding TCI state for a TRP 405 corresponding to the DCI. The TCI field of a DCI indicates the corresponding TCI state (for example, the TCI field of the first DCI indicates the first TCI state and the TCI field of the second DCI indicates the second TCI state).

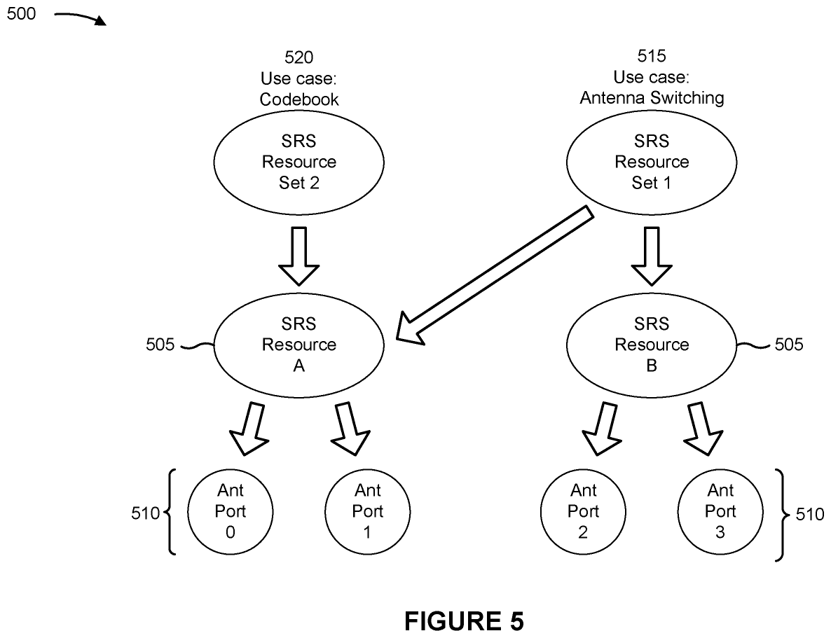

FIG. 5 is a diagram illustrating an example 500 of SRS resource sets, in accordance with the present disclosure.

A base station 110 may configure a UE 120 with one or more SRS resource sets to allocate resources for SRS transmissions by the UE 120. For example, a configuration for SRS resource sets may be indicated in a radio resource control (RRC) message (for example, an RRC configuration message or an RRC reconfiguration message). As shown by reference number 505, an SRS resource set may include one or more resources (for example, shown as SRS resources), which may include time resources or frequency resources (for example, a slot, a symbol, a resource block, or a periodicity for the time resources). For example, in some cases, an SRS resource set may include up to 16 SRS resources.

As shown by reference number 510, an SRS resource may include one or more antenna ports on which an SRS is to be transmitted (for example, in a time-frequency resource). Thus, a configuration for an SRS resource set may indicate one or more time-frequency resources in which an SRS is to be transmitted and may indicate one or more antenna ports on which the SRS is to be transmitted in those time-frequency resources. In some examples, the configuration for an SRS resource set may indicate a use case (for example, in an SRS-SetUse information element) for the SRS resource set. For example, an SRS resource set may have a use case of antenna switching, codebook, non-codebook, or beam management. The “use case” of an SRS resource set may also be referred to as a “usage” of the SRS resource set.

In some examples, a configured SRS resource set or a configured SRS resource may be indicated (for example, by the base station 110) via an SRI. For example, DCI scheduling a transmission of an SRS using a configured SRS resource may include an SRI (for example, in an SRI field of the DCI) to indicate the SRS resource or the SRS resource set to be used by the UE 120 to transmit the SRS.

An antenna switching SRS resource set may be used to indicate downlink channel state information (CSI) with reciprocity between an uplink and downlink channel. For example, when there is reciprocity between an uplink channel and a downlink channel, a base station 110 may use an antenna switching SRS (for example, an SRS transmitted using a resource of an antenna switching SRS resource set) to acquire downlink CSI (for example, to determine a downlink precoder to be used to communicate with the UE 120).

A codebook SRS resource set may be used to indicate uplink CSI when a base station 110 indicates an uplink precoder to the UE 120. For example, when the base station 110 is configured to indicate an uplink precoder to the UE 120 (for example, using a precoder codebook), the base station 110 may use a codebook SRS (for example, an SRS transmitted using a resource of a codebook SRS resource set) to acquire uplink CSI (for example, to determine an uplink precoder to be indicated to the UE 120 and used by the UE 120 to communicate with the base station 110). In some examples, virtual ports (for example, a combination of two or more antenna ports) with a maximum transmit power may be supported at least for a codebook SRS.

In some examples, the UE 120 may be configured with one SRS resource set (for example, only one) with a usage set to codebook (for example, the UE 120 may only be configured with one codebook SRS resource set). In some examples, the UE 120 may be configured with a plurality (for example, two) SRS resource sets for codebook based PUSCH transmission. In some examples, a codebook SRS resource set may include up to 4 SRS resources (for example, a maximum of 4 SRS resources may be configured for the codebook SRS resource set). Each SRS resource (for example, included in the codebook SRS resource set) may be configured with a quantity of antenna ports (for example, in a nrofSRS-Ports information element of an RRC configuration). An SRI in DCI scheduling a transmission of a codebook SRS may indicate one (for example, only one) SRS resource in a codebook SRS resource set. A quantity of ports configured for the indicated SRS resource (for example, in the nrofSRS-Ports information element) may identify a quantity of antenna ports for the PUSCH to be used to transmit the communication scheduled by the DCI. The UE 120 may transmit the communication scheduled by the DCI (for example, on the PUSCH) using the same spatial domain filter (for example, the same uplink beam) as the indicated SRS resource (for example, the SRS resource indicated by the SRI included in the DCI).

A size (for example, a quantity of bits) associated with an SRI may be based at least in part on a quantity of SRS resources included in a codebook SRS resource set. The size of the SRI may be defined, or otherwise fixed, by a wireless communication standard, such as the 3GPP (for example, in 3GPP Technical Specification 38.212). For example, a size of an SRI (for example, a quantity of bits associated with the SRI) for codebook based PUSCH may be defined according to the expression ┌log₂ (N_{SRS})┐, where N_{SRS} is the quantity of SRS resources included in a codebook SRS resource set configured by a higher layer parameter such as srs-ResourceSetToAddModList. For example, the equation described above may be used to identify a size of the SRI when a higher layer parameter indicates that a transmission is a codebook transmission (for example, usage of value ‘codebook’ indicated in higher layer parameter txConfig). In other words, the equation described above may be used to identify a size of the SRI for codebook based PUSCH transmissions.

A quantity of layers (for example, rank), a TPMI (for example, precoder), or a combination thereof, to be used by the UE 120 to transmit a codebook based communication scheduled by the DCI (for example, on the PUSCH), may be indicated via one or more TPMI fields in the DCI (for example, in a precoding information field or a quantity of layers field). A TPMI field may indicate a TPMI index. The UE 120 may identify a first table (such as a 3GPP-defined table) or another type of data structure based on one or more parameters for the codebook based communication based at least in part on a quantity of ports (for example, antenna ports) configured for the codebook based communication, a maximum rank for the codebook based communication, whether a power parameter (for example, FullpowerMode1) is configured for the codebook based communication, another parameter, or a combination thereof. The UE 120 may identify a row in the first table based at least in part on the TPMI index. The UE 120 may identify a column in the first table based at least in part on whether the ports configured for the codebook based communication are permitted to be fully coherent, partially coherent, non-coherent, or a combination thereof. The intersection of the identified row and the identified column indicates a quantity of layers (a rank) for the codebook based communication and a TPMI for the codebook based communication.

The UE 120 may then identify a second table (such as a 3GPP-defined table) or another type of data structure based at least in part on one or more parameters for the codebook based communication, such as the quantity of layers for the codebook based communication, the quantity of ports for the codebook based communication, or a combination thereof. The second table may indicate a plurality of candidate precoders (or candidate precoding matrices), each associated with a TPMI. The UE 120 may identify the precoder, that is to be used for the codebook based communication, among the plurality of candidate precoders. In particular, the UE 120 may identify the precoder that is associated with the TPMI indicated at the intersection of the identified row and the identified column of the first table.

As used herein, “layer” may refer to a data stream. In the context of SDM, layers may be transmitted in a spatially multiplexed manner, in which each of a plurality of layers occupies respective spatial resources. Accordingly, a “layer’ may be referred to as a “spatial layer” in the context of SDM. “Rank” may refer to a quantity of layers associated with a given communication. A size (for example, a quantity of bits) associated with the SRI may be based at least in part on a quantity of SRS resources included in the codebook SRS resource set.

A non-codebook SRS resource set may be used to indicate uplink CSI when the UE 120 selects an uplink precoder (for example, instead of the base station 110 indicating an uplink precoder to be used by the UE 120). For example, when the UE 120 is configured to select an uplink precoder, the base station 110 may use a non-codebook SRS (for example, an SRS transmitted using a resource of a non-codebook SRS resource set) to acquire uplink CSI. In this case, the non-codebook SRS may be precoded using a precoder selected by the UE 120 (for example, which may be indicated to the base station 110). A beam management SRS resource set may be used for indicating CSI for millimeter wave communications.

In some examples, the UE 120 may be configured with one SRS resource set (for example, only one SRS resource set) with a usage set to non-codebook (for example, the UE 120 may be configured with only one non-codebook SRS resource set). In some examples, a non-codebook SRS resource set may include up to 4 SRS resources (for example, a maximum of 4 SRS resources may be configured for the non-codebook SRS resource set). In some examples, each SRS resource included in the non-codebook SRS resource set may be associated with one (for example, a single) antenna port (for example, a single SRS port). A non-codebook SRS resource set also may be used to facilitate non-codebook-based PUSCH transmission. For example, an SRI in a DCI may indicate one or more SRS resources from a non-codebook based PUSCH transmission (for example, a single SRI may include one or more SRS resources). A quantity of SRS resources indicated by the SRI may indicate a quantity of layers (for example, a rank) associated with the non-codebook based transmission scheduled by the DCI (for example, to be transmitted via the PUSCH). The communication scheduled by the DCI may use the same precoder and the same spatial domain filter (for example, the same uplink beam) as the SRS resource(s) indicated by the SRI.

An SRS resource can be configured as periodic, semi-persistent (sometimes referred to as semi-persistent scheduling (SPS)), or aperiodic. A periodic SRS resource may be configured via a configuration message that indicates a periodicity of the SRS resource (for example, a slot-level periodicity, where the SRS resources occurs every Y slots) and a slot offset. In some cases, a periodic SRS resource may always be activated, and may not be dynamically activated or deactivated. A semi-persistent SRS resource may also be configured via a configuration message that indicates a periodicity and a slot offset for the semi-persistent SRS resource, and may be dynamically activated and deactivated (for example, using DCI or a MAC control element (CE) (MAC-CE)). An aperiodic SRS resource may be triggered dynamically, such as via DCI (for example, UE-specific DCI or group common DCI) or a MAC-CE.

In some examples, the UE 120 may be configured with a mapping between SRS ports (for example, antenna ports) and corresponding SRS resources. The UE 120 may transmit an SRS on a particular SRS resource using an SRS port indicated in the configuration. In some examples, an SRS resource may span N adjacent symbols within a slot (for example, where N equals 1, 2, or 4). The UE 120 may be configured with X SRS ports (for example, where X≤4). In some examples, each of the X SRS ports may mapped to a corresponding symbol of the SRS resource and used for transmission of an SRS in that symbol.

As shown in FIG. 5, in some examples, different SRS resource sets indicated to the UE 120 (for example, having different use cases) may overlap (for example, in time or in frequency, such as in the same slot). For example, as shown by reference number 515, a first SRS resource set (for example, shown as SRS Resource Set 1) is shown as having an antenna switching use case. As shown, this example antenna switching SRS resource set includes a first SRS resource (shown as SRS Resource A) and a second SRS resource (shown as SRS Resource B). Thus, antenna switching SRS may be transmitted in SRS Resource A (for example, a first time-frequency resource) using antenna port 0 and antenna port 1 and may be transmitted in SRS Resource B (for example, a second time-frequency resource) using antenna port 2 and antenna port 3.

As shown by reference number 520, a second SRS resource set (for example, shown as SRS Resource Set 2) may be a codebook use case. As shown, this example codebook SRS resource set includes only the first SRS resource (shown as SRS Resource A). Thus, codebook SRSs may be transmitted in SRS Resource A (for example, the first time-frequency resource) using antenna port 0 and antenna port 1. In this case, the UE 120 may not transmit codebook SRSs in SRS Resource B (for example, the second time-frequency resource) using antenna port 2 and antenna port 3.

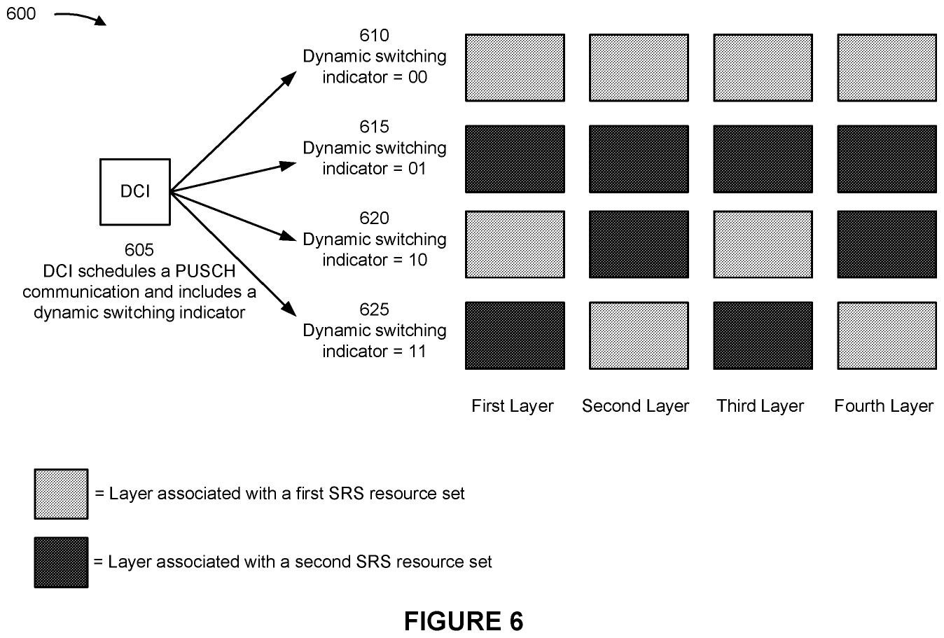

FIG. 6 is a diagram illustrating an example 600 of dynamic switching between sTRP communications and mTRP communications, in accordance with the present disclosure. For example, in some cases, a UE may communicate with two TRPs (for example, in a similar manner as described in connection with FIG. 4). Communication with more than one TRP may be referred to as mTRP communication, whereas communication with only one TRP may be referred to sTRP communication. In mTRP, the two sets of layers for a PUSCH communication can correspond to two SRS resource sets and to separate sets of parameters for the PUSCH communication. For example, a DCI transmission can indicate two sets of transmission parameters (such as two beams and two sets of power control parameters) using two corresponding SRI fields. For codebook-based PUSCH, the DCI transmission also indicates two sets of precoding parameters (such as two quantities of layers and two TPMIs) using two corresponding TPMI fields.

A PUSCH communication can be transmitted using SDM, in which layers of the PUSCH communication may correspond to the same or different transmission parameters (beam/spatial relation, power control, precoding). In some cases, a PUSCH communication that are scheduled by a single DCI transmission can belong to two sets of layers, where each set of layers has its own transmission parameters and precoding parameters.

In some cases, a UE may be configured to dynamically switch between sTRP communication and mTRP communication. For dynamic switching between sTRP and mTRP (for example, dynamic switching between one set of transmission parameters and precoding parameters for a PUSCH communication and two sets of transmission parameters and precoding parameters for a plurality of layers for a PUSCH communication), a wireless communication standard (for example, the 3GPP) may introduce a new field in a DCI format. The new field, which may be referred to as a dynamic switching field or a dynamic switching indicator, may be 2 bits and may indicate that the UE is to use a first set of parameters only (for example, to transmit to a first TRP, TRP1); use a second set of parameters only (for example, to transmit to a second TRP, TRP2); use both sets of parameters for two sets of layers with a first order (TRP1, TRP2); or use both sets of parameters for two sets of layers with a second order (TRP2, TRP1), which may be referred to as a reversed order. In the case of TDM communications, the rank and antenna ports are the same across all the layers.

For example, as shown in FIG. 6 and by reference number 605, a DCI may schedule 4 layers of a PUSCH communication. The DCI may indicate a first SRS resource set (for example, via a first SRI included in the DCI) and a second SRS resource set (for example, via a second SRI included in the DCI). As described in more detail elsewhere herein, an SRS resource or SRS resource set (for example, indicated via an SRI) may indicate a beam or a set of transmission parameters to be used for the layers of the PUSCH communication scheduled by the DCI. The DCI may also include the dynamic switching indicator (for example, may include a dynamic switching field). A value (for example, a codepoint) of the dynamic switching indicator may indicate whether the uplink transmission scheduled by the DCI is an sTRP communication (for example, as shown by reference number 610, where the value of the dynamic switching indicator is “00,” and by reference number 615, where the value of the dynamic switching indicator is “01”) or is an mTRP communication (for example, as shown by reference number 620, where the value of the dynamic switching indicator is “10,” and by reference number 625, where the value of the dynamic switching indicator is “11”). Additionally, the value (for example, a codepoint) of the dynamic switching indicator may indicate which SRS resource set (for example, in the case of sTRP communications) is to be associated with the uplink transmission scheduled by the DCI. In the case of mTRP communications, the value (for example, a codepoint) of the dynamic switching indicator may indicate an order or pattern (for example, of the multiple SRS resource sets) to be used by the UE to transmit a PUSCH communication scheduled by the DCI.

For example, as shown by reference number 610, a first value or codepoint (for example, “00”) of the dynamic switching indicator may indicate that a PUSCH communication scheduled by the DCI is to be an sTRP communication. Additionally, the first value or codepoint (for example, “00”) may indicate that the layers of the PUSCH communication (layers 1-4) are to be associated with the first SRS resource set (for example, indicated by the first SRI included in the DCI). Therefore, the UE may transmit the PUSCH communication using a beam or a set of transmission parameters indicated by the first SRS resource set (for example, indicated by an SRS resource included in the first SRS resource set).

As another example, and as shown by reference number 615, a second value or codepoint (for example, “01”) of the dynamic switching indicator may indicate that the PUSCH communication scheduled by the DCI is to be an sTRP communication. Additionally, the second value or codepoint (for example, “01”) may indicate that the layers of the PUSCH communication are to be associated with the second SRS resource set (for example, indicated by the second SRI included in the DCI). Therefore, the UE may transmit the PUSCH communication using a beam or a set of transmission parameters indicated by the second SRS resource set (for example, indicated by an SRS resource included in the second SRS resource set).

As another example, and as shown by reference number 620, a third value or codepoint (for example, “10”) of the dynamic switching indicator may indicate that the PUSCH communication scheduled by the DCI is to be an mTRP communication. For example, the third value or codepoint (for example, “10”) may indicate that both the first SRS resource set and the second SRS resource set are to be used to identify beams or transmission parameters for the PUSCH communication. Additionally, the third value or codepoint (for example, “10”) may indicate a first layer assignment for the PUSCH communication. For example, the first pattern may indicate that the first layer and the third layer are to be associated with the first SRS resource set and that the second layer and the fourth layer are to be associated with the second SRS resource set. The UE may transmit the first layer of the PUSCH communication and the third layer of the PUSCH communication using a first beam or a first set of transmission parameters indicated by the first SRS resource set. The UE may transmit the second layer of the PUSCH communication and the fourth layer of the PUSCH communication using a second beam or a second set of transmission parameters indicated by the second SRS resource set. For example, the UE may transmit the first layer of the PUSCH communication and the third layer of the PUSCH communication to a first TRP and may transmit the second layer of the PUSCH communication and the fourth layer of the PUSCH communication to a second TRP. The first pattern shown in FIG. 6 is provided as an example and other patterns are also possible, such as a sequential pattern in which the first layer of the PUSCH communication and the second layer of the PUSCH communication are associated with the first SRS resource set and the third layer of the PUSCH communication and the fourth layer of the PUSCH communication are associated with the second SRS resource set.

As yet another example, and as shown by reference number 625, a fourth value or codepoint (for example, “11”) of the dynamic switching indicator may indicate that the PUSCH communication scheduled by the DCI is to be an mTRP communication. For example, the fourth value or codepoint (for example, “11”) may indicate that both the first SRS resource set and the second SRS resource set are to be used to identify beams or transmission parameters for the PUSCH communication. Additionally, the fourth value or codepoint (for example, “11”) may indicate a second pattern associated with the PUSCH communication. For example, the second pattern may indicate that the first layer of the PUSCH communication and the third layer of the PUSCH communication are to be associated with the second SRS resource set and that the second layer of the PUSCH communication and the fourth layer of the PUSCH communication are to be associated with the first SRS resource set. The UE may transmit the first layer of the PUSCH communication and the third layer of the PUSCH communication using the second beam or the second set of transmission parameters indicated by the second SRS resource set. The UE may transmit the second layer of the PUSCH communication and the fourth layer of the PUSCH communication using the first beam or the first set of transmission parameters indicated by the first SRS resource set. For example, the UE may transmit the first layer of the PUSCH communication and the third layer of the PUSCH communication to the second TRP and may transmit the second layer of the PUSCH communication and the fourth layer of the PUSCH communication to the first TRP. The second pattern shown in FIG. 6 is provided as an example and other patterns are also possible, such as a sequential pattern in which the first layer of the PUSCH communication and the second layer of the PUSCH communication are associated with the second SRS resource set and the third layer of the PUSCH communication and the fourth layer of the PUSCH communication are associated with the first SRS resource set.

In this way, the UE may be scheduled to dynamically switch between sTRP communication and mTRP communication. Additionally, a single DCI may schedule the UE to transmit PUSCH repetitions in a TDM manner, in which the layers of the PUSCH communication correspond to different transmission parameters (beam/spatial relation, power control, precoding).

In the case of SDM for PUSCH, different sets of layers for an SDM PUSCH communication may also have different precoding parameters (for example, different quantities of layers, different TPMIs). For example, a first set of layers may be associated with a first set of transmission parameters (such as a first beam, a first set of power control parameters, or a combination thereof) and a first set of precoding parameters (such as a first quantity of layers, a first TPMI index, or a combination thereof). A second set of layers may be associated with a second set of transmission parameters (such as a second beam, a second set of power control parameters, or a combination thereof) and a second set of precoding parameters (such as a second quantity of layers, a second TPMI index, or a combination thereof). The first set of precoding parameters indicated by a first TPMI field in the DCI, and the second set of precoding parameters may be indicated by a second TPMI field in the DCI. The dynamic switching indicator may function in a similar manner for the TPMI fields for indicating different sets of precoding parameters for different sets of layers of the PUSCH communication as for the transmission parameters described above.

In some cases, a number of rank combinations can be supported, such as, for example, rank combinations 1+1 (for example, where the first set of layers includes a single layer and the second set of layers includes a single layer), 1+2 (for example, where the first set of layers includes a single layer and the second set of layers includes two layers), 2+1 (for example, where the first set of layers includes two layers and the second set of layers includes a single layer), 2+2 (for example, where the first set of layers includes two layers and the second set of layers includes two layers), 1+3 (for example, where the first set of layers includes a single layer and the second set of layers includes three layers), or 3+1 (for example, where the first set of layers includes three layers and the second set of layers includes a single layer), among other examples.

However, a UE that is scheduled to spatially transmit a PUSCH communication using SDM may be unable to determine a length (such as a quantity of bits) of a first TPMI field, in DCI that schedules the PUSCH communication, associated with the first set of layers. Moreover, the UE may be unable to determine a length of a second TPMI field, in the DCI that schedules the PUSCH communication, associated with the second set of layers. As a result, the UE may be unable to interpret the first TPMI field and the second TPMI field. Thus, the UE may be unable to identify respective precoders for transmitting the PUSCH communication using the first set of layers and the second set of layers.

Various aspects relate generally to SRI signaling and TPMI signaling for SDM. Some aspects more specifically relate to including, in DCI that schedules a PUSCH communication, a plurality of fields associated with the PUSCH communication for SDM. In some aspects, the plurality of fields are configured to indicate transmission parameters and precoding parameters for a plurality of layers (spatial layers) of the PUSCH communication. In some aspects, a UE may use one or more techniques to interpret the first TPMI field and the second TPMI field to identify precoders for the plurality of layers of the PUSCH communication. In some aspects, the DCI is configured to further include a dynamic switching indicator for switching between sTRP transmission of the PUSCH communication and mTRP transmission of the PUSCH communication for SDM. In some aspects, the UE is configured to use one or more techniques to interpret the first TPMI field and the second TPMI field based at least in part on the dynamic switching indicator to support sTRP transmission and mTRP (SDM) transmission.

Particular aspects of the subject matter described in this disclosure can be implemented to realize one or more of the following potential advantages. In some examples, the described techniques can be used to enable the UE to transmit the PUSCH communication using different transmission parameters for different subsets of the plurality of layers, using different precoding parameters for different subsets of the plurality of layers, or a combination thereof, which increases the flexibility and configurability of SDM for PUSCH. In some examples, the described techniques can be used to enable the UE to dynamically switch between sTRP transmission of PUSCH communications and mTRP (SDM) transmission of PUSCH communications.

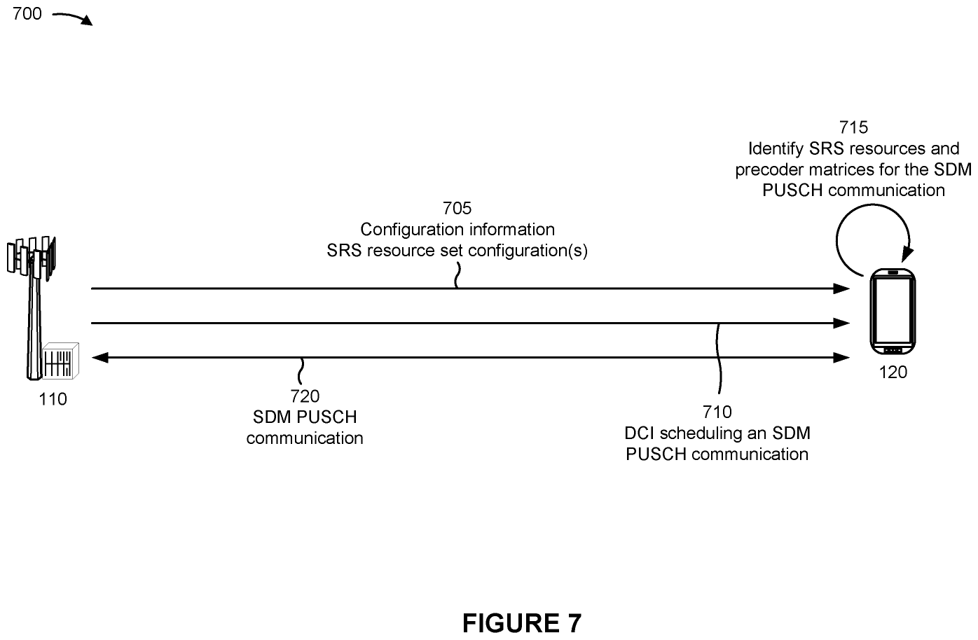

FIGS. 7-9 are diagrams illustrating examples associated with SRI and TPMI signaling for uplink SDM, in accordance with the present disclosure. FIG. 7 is a diagram illustrating an example 700 associated with SRI and TPMI signaling for uplink SDM. In particular, the example 700 includes an example of the base station 110 providing the UE 120 with information for identifying one or more parameters for transmitting a PUSCH communication using SDM. As shown in FIG. 7, the example 700 includes communication between a base station 110 and a UE 120. The base station 110 and the UE 120 communicate on an access link that includes an uplink and a downlink. The base station 110 and the UE 120 may be included in a wireless network such as the wireless network 100.

As shown in FIG. 7, the base station 110 may transmit (and the UE 120 may receive) a downlink communication 705. The downlink communication 705 may include configuration information. In some aspects, the UE 120 receives configuration information from another device (such as another base station or another UE). In some aspects, the UE 120 receives the configuration information via RRC signaling, MAC signaling (for example, in one or more MAC-CEs), another type of downlink signaling, or a combination thereof.

The configuration information may indicate an SRS configuration. For example, the configuration information may configure or indicate one or more SRS resource sets. The one or more SRS resource sets may be indicated in the configuration information by one or more SRS-ResourceSet information elements. In some aspects, the configuration information configures a first SRS resource set and a second SRS resource set. The first SRS resource set and the second SRS resource set may be codebook SRS resource sets. In other words, the first SRS resource set and the second SRS resource set are associated with a codebook usage or use case. The first SRS resource set may include a first quantity of SRS resources (referred to herein as N1), and the second SRS resource set may include a second quantity of SRS resources (referred to herein as N2).

In some aspects, the configuration information may be associated with an SDM configuration. The SDM configuration may be associated with a PUSCH having a first set of layers (a first one or more layers) and a second set of layers (a second one or more layers). The first set of layers may include a first quantity of layers and the second set of layers may include a second quantity of layers, the first quantity and the second quantity being either the same quantity or different quantities.

In some aspects, the UE 120 may configure itself for communicating with the base station 110. In some aspects, the UE 120 may configure the UE 120 based at least in part on the configuration information. In some aspects, the UE 120 may be configured to perform one or more operations described herein. In some aspects, the UE 120 may transmit, and the base station 110 may receive, an indication of a capability of the UE 120 to communicate using SRI signaling for SDM PUSCH communications as described herein. The UE 120 may transmit the indication via RRC signaling, one or more MAC-CEs, a physical uplink control channel (PUCCH) communication, another type of uplink communication, or a combination thereof.

As further shown in FIG. 7, the base station 110 may transmit (and the UE 120 may receive) another downlink communication 710. In some aspects, the downlink communication 705 and the downlink communication 710 are the same downlink communication. In some aspects, the downlink communication 705 and the downlink communication 710 are different downlink communications.

The downlink communication 710 includes DCI. The DCI may schedule a transmission of an SDM PUSCH communication for the UE 120. The SDM PUSCH communication may include a codebook based SDM PUSCH communication. The DCI may include a first SRI field, a second SRI field, a first TPMI field, and a second TPMI field. The first SRI field, the second SRI field, the first TPMI field, and the second TPMI field are configured to indicate parameters for transmitting the SDM PUSCH communication using one or more sets of layers (spatial layers). In this way, the base station 110 is enabled to indicate different sets of parameters for different sets of layers (spatial layers or SDM layers) for the SDM PUSCH communication.

The first SRI field may be associated with the first SRS resource set, and may indicate one or more first transmission parameters for one or more first layers (one or more first spatial layers or SDM layers) of the SDM PUSCH communication. The second SRI field may be associated with the second SRS resource set, and may indicate one or more second transmission parameters for one or more second layers (one or more second spatial layers or SDM layers) of the SDM PUSCH communication. The first TPMI field may be associated with the one or more first layers and may indicate one or more first precoding parameters for the one or more first layers. The second TPMI field may be associated with the one or more second layers and may indicate one or more second precoding parameters for the one or second more layers.

The one or more first transmission parameters may include one or more first beams for the one or more first layers, one or more power control parameters for the one or more first layers, one or more first parameters for the one or more first layers, or a combination thereof. The one or more first beams may include one or more transmit beams on which the UE 120 is to transmit the SDM PUSCH communication using the one or more first layers. The one or more first power control parameters may include a transmit power parameter, an open loop power control parameter, a closed loop power control parameter, another power control parameter, or a combination thereof for transmitting the SDM PUSCH communication using the one or more first layers.

The one or more second transmission parameters may include one or more second beams for the one or more second layers, one or more second power control parameters for the one or more second layers, one or more other parameters for the one or more second layers, or a combination thereof. The one or more second beams may include one or more transmit beams on which the UE 120 is to transmit the SDM PUSCH communication using the one or more second layers. The one or more second power control parameters may include a transmit power parameter, an open loop power control parameter, a closed loop power control parameter, another power control parameter, or a combination thereof for transmitting the SDM PUSCH communication using the one or more second layers.

In some aspects, the one or more first beams and the one or more second beams are the same one or more beams. In some aspects, at least a subset of the one or more first beams and at least a subset of the one or more second beams are different beams. In some aspects, the one or more first power control parameters and the one or more second power control parameters are the same one or more power control parameters (or the same power control parameters with the same values). In some aspects, at least a subset of the one or more first power control parameters and at least a subset of the one or more second beams are different power control parameters (or power control parameters having different values).

The one or more first precoding parameters may include a first codebook-based precoder index (such as a TPMI index, or an index into a TPMI identification table described above) for the one or more first layers, a first quantity of layers (a rank, in other words) for the one or more first layers, another precoding parameter, or a combination thereof. The UE 120 may use the one or more first precoding parameters to pre-code the one or more first layers of the SDM PUSCH communication.

The one or more second precoding parameters may include a second codebook-based precoder index (such as a TPMI index, or an index into a TPMI identification table described above) for the one or more second layers, a second quantity of layers (a rank, in other words) for the one or more second layers, another precoding parameter, or a combination thereof. The UE 120 may use the one or more second precoding parameters to pre-code the one or more second layers of the SDM PUSCH communication.

In some aspects, the first codebook-based precoder index and the second codebook-based precoder index are the same codebook-based precoder index. In some aspects, the first codebook-based precoder index and the second codebook-based precoder index are different codebook-based precoder indices. In some aspects, the first quantity of layers and the second quantity of layers are the same quantity of layers. In some aspects, the first quantity of layers and the second quantity of layers are different quantities of layers.

The DCI may further include a dynamic switching indicator field. The dynamic switching indicator field may indicate whether the first SRI field, the second SRI field, the first TPMI field, and the second TPMI field are associated with a single TRP for sTRP communication, or whether the first SRI field, the second SRI field, the first TPMI field, and the second TPMI field are associated with a plurality of TRPs for mTRP communication. For example, the dynamic switching indicator field may include a value (such as a value ‘00’ or ‘01’) that indicates that the UE 120 is to transmit one or more repetitions (for example, time domain repetitions or repetitions that are staggered in time) of a PUSCH communication to a single TRP. As another example, the dynamic switching indicator field may include a value (such as a value ′10 or ′11) that indicates that the UE 120 is to transmit the one or more first layers of the SDM PUSCH communication to a first TRP and the one or more second layers of the SDM PUSCH communication to a second TRP.

As further shown in FIG. 7, the UE 120 may perform an action 715, which may include identifying SRS resources and precoder matrices for the SDM PUSCH communication. In particular, the UE 120 may identify the SRS resources and the precoder matrices for precoding and transmitting the one or more first layers and the one or more second layers of the SDM PUSCH communication. The UE 120 may identify the SRS resources and the precoder matrices based at least in part on the DCI. In particular, the UE 120 may identify the SRS resources and the precoder matrices based at least in part on the first SRI field, the second SRI field, the first TPMI field, and the second TPMI field included in the DCI.

Moreover, the UE 120 may identify the SRS resources and the precoder matrices based at least in part on the value indicated by the dynamic switching indicator field in the DCI. In other words, the UE 120 may identify the SRS resources and the precoder matrices based at least in part on whether the UE 120 is to transmit a PUSCH communication to a single TRP, or to transmit the one or more first layers of the SDM PUSCH communication to a first TRP and the one or more second layers of the SDM PUSCH communication to a second TRP.

As an example, the UE 120 may interpret the first SRI field and the second SRI field as separate SRI fields that indicate separate sets of transmission parameters based at least in part on determining that the dynamic switching indicator field indicates that the first SRI field and the first TPMI field are associated with a first TRP, and the second SRI field and the second TPMI field are associated with a second TRP (mTRP). As another example, the UE 120 may interpret the first SRI field and the second SRI field as a joint SRI field that indicates a single set of transmission parameters based at least in part on determining that the dynamic switching indicator field indicates that the first SRI field, the first TPMI field, the second SRI field, and the second TPMI field are all associated with a single (same) TRP (sTRP). In these aspects, the one or more first transmission parameters and the one or more second transmission parameters are the same set of transmission parameters.

As another example, the UE 120 may interpret the first TPMI field and the second TPMI field as separate TPMI fields that indicate separate sets of transmission parameters based at least in part on determining that the dynamic switching indicator field indicates that the first SRI field and the first TPMI field are associated with a first TRP, and the second SRI field and the second TPMI field are associated with a second TRP (mTRP). As another example, the UE 120 may interpret the first TPMI field and the second TPMI field as a joint TPMI field that indicates a single set of precoding parameters based at least in part on determining that the dynamic switching indicator field indicates that the first SRI field, the first TPMI field, the second SRI field, and the second TPMI field are all associated with a single (same) TRP (sTRP). In these aspects, the one or more first transmission parameters and the one or more second transmission parameters are the same set of transmission parameters.

The UE 120 may further identify the precoder matrices based at least in part on a size of the first TPMI field and a size of the second TPMI field. The UE 120 is configured to determine the size of the first TPMI field and the size of the second TPMI field, which enables the UE 120 to correctly interpret the first TPMI field and the second TPMI field. This enables the UE 120 to identify the correct quantity of layers (rank) and the correct TPMI indices for identifying the precoder matrices using the tables described above.

The UE 120 may determine the size of the first TPMI field and the size of the second TPMI field based at least in part on one or more parameters. The one or more parameters may include a maximum rank (Lₘₐₓ¹) associated with the first SRS resource set, a maximum rank (Lₘₐₓ²) associated with the second SRS resource set, an overall maximum rank (Lₘₐₓ) for the first SRS resource set and the second SRS resource set, a maximum quantity of ports (p₁^{max}) (antenna ports, PUSCH ports, or another type of ports) for the first SRS resource set, a maximum quantity of ports (p₂^{max}) (antenna ports, PUSCH ports, or another type of ports) for the second SRS resource set, a first quantity (p₁) of one or more first ports (antenna ports, PUSCH ports, or another type of ports) for a first SRS resource associated with the one or more first layers, a second quantity (p₂) of one or more second ports (antenna ports, PUSCH ports, or another type of ports) for a second SRS resource associated with the one or more second layers, another parameter, or some combination thereof. Additionally or alternatively, the UE 120 may determine the size of the first TPMI field based at least in part on whether the one or more first ports are non-coherent, partially coherent, fully coherent, or are permitted to be one or more thereof. Additionally or alternatively, the UE 120 may determine the size of the first TPMI field and the size of the second TPMI field based at least in part on whether full power mode (fullpowerMode1) is configured for the UE 120.

In some aspects, one or more of the maximum rank (Lₘₐₓ¹) associated with the first SRS resource set or the maximum rank (Lₘₐₓ²) associated with the second SRS resource set are RRC configured for the UE 120. For example, the base station 110 may transmit an RRC communication to the UE 120 to indicate one or more of the maximum rank (Lₘₐₓ¹) associated with the first SRS resource set or the maximum rank (Lₘₐₓ²) associated with the second SRS resource set. In some aspects, one or more of the maximum rank (Lₘₐₓ¹) associated with the first SRS resource set or the maximum rank (Lₘₐₓ²) associated with the second SRS resource set are indicated in a wireless communication standard or specification, such as a 3GPP technical specification. In some aspects, one or more of the maximum rank (Lₘₐₓ¹) associated with the first SRS resource set or the maximum rank (Lₘₐₓ²) associated with the second SRS resource set are indicated in a configuration at the UE 120 (for example, prior to deployment of the UE 120 into the wireless network).

In some aspects, the overall maximum rank (Lₘₐₓ) for the first SRS resource set and the second SRS resource set is RRC configured for the UE 120 (or indicated in a wireless communication standard or specification), and the UE 120 is configured to determine the maximum rank (Lₘₐₓ¹) associated with the first SRS resource set and the maximum rank (Lₘₐₓ²) associated with the second SRS resource set are RRC configured for the UE 120 based at least in part on the overall maximum rank (Lₘₐₓ). For example, the UE 120 may be configured to determine the maximum rank (Lₘₐₓ¹) associated with the first SRS resource set and the maximum rank (Lₘₐₓ²) associated with the second SRS resource set based at least in part on:

$${L}_{max}^{1} = ⌈ \frac{{L}_{max}}{2} ⌉ , {L}_{max}^{2} = {L}_{max} - ⌈ \frac{{L}_{max}}{2} ⌉$$

In some aspects, the maximum rank (Lₘₐₓ¹) associated with the first SRS resource set and the maximum rank (Lₘₐₓ²) associated with the second SRS resource set are a same maximum rank value. In some aspects, the maximum rank (Lₘₐₓ¹) associated with the first SRS resource set and the maximum rank (Lₘₐₓ²) associated with the second SRS resource set are different maximum rank values.

In some aspects, the first quantity (p₁) of one or more first ports and the second quantity (p₂) of one or more second ports are the same quantity of ports. In some aspects, the first quantity (p₁) of one or more first ports and the second quantity (p₂) of one or more second ports are different quantities of ports. Examples of port quantity combinations for the first quantity (p₁) of one or more first ports and the second quantity (p₂) of one or more second ports include p₁+p₂=2+1, 1+2, 1+4, 4+1, 2+4, or 4+2. However, other combinations are within the scope of the present disclosure.

In some aspects, fullpowerMode1 is configured for the UE 120. In other words, an uplink full power transmission information element (ul-FullPowerTransmission IE) is set or equal to fullpowerMode1 for the UE 120. In some aspects, fullpowerMode1 is not configured for the UE 120. In other words, an uplink full power transmission information element (ul-FullPowerTransmission IE) is set or equal to another value for the UE 120, such as fullpowerMode2.

In some aspects, the one or more first ports and the one or more second ports are configured with the same coherency type. For example, the one or more first ports and the one or more second ports may both be configured to be non-coherent. As another example, the one or more first ports and the one or more second ports may both be configured to be partially coherent. As another example, the one or more first ports and the one or more second ports may both be configured to be fully coherent. In some aspects, the one or more first ports and the one or more second ports are configured with different coherency types. For example, the one or more first ports may be configured to be non-coherent, whereas the one or more second ports may be configured as partially coherent or fully coherent. As another example, the one or more first ports may be configured to be partially-coherent, whereas the one or more second ports may be configured as non-coherent or fully coherent. As another example, the one or more first ports may be configured to be non-coherent, whereas the one or more second ports may be configured as partially coherent or fully coherent.

As described above, a joint SRS may be used in the DCI to indicate an SRS resource in either the first SRS resource set or the second SRS resource set for sTRP. Moreover, a joint TPMI field may be used in the DCI to indicate a precoder and quantity of layers for sTRP. The joint TPMI field may include a combination of the first TPMI field and the second TPMI field. The UE 120 may determine the quantity of bits for the joint TPMI field based at least in part on a maximum rank for sTRP, a quantity of ports (antenna ports, PUSCH ports, or another type of ports) for sTRP, another sTRP parameter, or a combination thereof.

In some aspects, the UE 120 determines the maximum rank for sTRP to be equal to or less than the maximum rank (Lₘₐₓ¹) associated with the first SRS resource set. In some aspects, the UE 120 determines the maximum rank for sTRP to be equal to or less than the maximum rank (Lₘₐₓ²) associated with the second SRS resource set. In some aspects, the UE 120 determines the maximum rank for sTRP to be equal to or less than the maximum rank (Lₘₐₓ¹) associated with the first SRS resource set, and to be equal to or less than the maximum rank (Lₘₐₓ²) associated with the second SRS resource set. In some aspects, the UE 120 determines the maximum rank for sTRP to be equal to the lesser of a default rank (for example, 4 or another default rank) or a combination of the maximum rank (Lₘₐₓ¹) associated with the first SRS resource set and the maximum rank (Lₘₐₓ²) associated with the second SRS resource set (for example, min (4, Lₘₐₓ¹+Lₘₐₓ²)).

In some aspects, the UE 120 determines the quantity of ports for sTRP to be equal to or less than the first quantity (p₁) of one or more first ports. In some aspects, the UE 120 determines the quantity of ports for sTRP to be equal to or less than the second quantity (p₂) of one or more second ports. In some aspects, the UE 120 determines the maximum rank for sTRP to be equal to or less than the first quantity (p₁) of one or more first ports, and to be equal to or less than the second quantity (p₂) of one or more second ports. In some aspects, the UE 120 determines the maximum rank for sTRP to be equal to the lesser of a default quantity of ports (for example, 4, 8, or another default quantity of ports) or a combination of the first quantity (p₁) of one or more first ports and the second quantity (p₂) of one or more second ports (for example, min (4, p₁+p₂), or min (8, p₁+p₂)).

In some aspects, zero padding is added to the first TPMI field, the second TPMI field, the joint TPMI field, or a combination thereof. Zero padding includes extra bits that are set or configured to 0-values as placeholders. Zero padding may be used in implementations where the combination of the quantity of bits in the first TPMI field and the second TPMI field, and the quantity of bits for the joint TPMI field, are different quantities. The zero padding therefore enables the combined size of the first TPMI field and the second TPMI field, and the size of the joint TPMI field, to be equalized. The UE 120 may determine the overall number of bits (and thus, the quantity of zero padding needed) for the first TPMI field, the second TPMI field, or the joint TPMI field as the greater of the quantity of bits for sTRP (for the joint TPMI field) or the quantity of bits for mTRP (SDM). The quantity of bits for mTRP (SDM) includes the quantity of bits for the first TPMI field and the quantity of bits for the second TPMI field.

To identify a first precoder (or a first precoder matrix) for precoding the one or more first layers of the SDM PUSCH communication, the UE 120 may identify a first table (such as a 3GPP-defined table) or another type of data structure for the first TPMI field based at least in part on the maximum rank (Lₘₐₓ¹) associated with the first SRS resource set and the first quantity (p₁) of the one or more first ports for the first SRS resource. The UE 120 may identify a row in the first table based at least in part on the first TPMI index identified by the first TPMI field (for example, based on the size of the first TPMI field and the value indicated by the first TPMI field). The UE 120 may identify a column in the first table based at least in part on whether the one or more first ports are permitted to be fully coherent, partially coherent, non-coherent, or a combination thereof. The intersection of the identified row and the identified column indicates a first quantity of layers (a first rank) for the one or more first layers of the SDM PUSCH communication, and a first TPMI for the one or more first layers of the SDM PUSCH communication. The UE 120 may then identify a second table (such as a 3GPP-defined table) or another type of data structure based at least in part on the first quantity of layers and the first quantity of the one or more first ports. The UE 120 may identify the first precoder (or the first precoder matrix) that is associated with the first TPMI in the second table.

To identify a second precoder (or a second precoder matrix) for precoding the one or more second layers of the SDM PUSCH communication, the UE 120 may identify a first table (such as a 3GPP-defined table) or another type of data structure for the second TPMI field based at least in part on the maximum rank (Lₘₐₓ²) associated with the second SRS resource set and the second quantity (p₂) of the one or more second ports for the second SRS resource. The UE 120 may identify a row in the first table based at least in part on the second TPMI index identified by the second TPMI field (for example, based on the size of the second TPMI field and the value indicated by the second TPMI field). The UE 120 may identify a column in the first table based at least in part on whether the one or more second ports are permitted to be fully coherent, partially coherent, non-coherent, or a combination thereof. The intersection of the identified row and the identified column indicates a second quantity of layers (a second rank) for the one or more second layers of the SDM PUSCH communication, and a second TPMI for the one or more second layers of the SDM PUSCH communication. The UE 120 may then identify a second table (such as a 3GPP-defined table) or another type of data structure based at least in part on the second quantity of layers and the second quantity of the one or more second ports. The UE 120 may identify the second precoder (or the second precoder matrix) that is associated with the second TPMI in the second table.

The UE 120 may pre-code the one or more first layers of the SDM PUSCH communication using the first precoder (or the first precoder matrix). The UE 120 may pre-code the one or more second layers of the SDM PUSCH communication using the second precoder (or the second precoder matrix).

As further shown in FIG. 7, the UE 120 may transmit the SDM PUSCH communication 720 to a single TRP of the base station 110, to a plurality of TRPs of the base station 110, or to a plurality of base stations 110 operating as respective TRPs. For example, the UE 120 may transmit one or more repetitions of the SDM PUSCH communication to the single TRP of the base station 110 based at least in part on the dynamic switching indicator field in the DCI indicating that sTRP mode is configured for transmission of a PUSCH communication.

As another example, the UE 120 may transmit the one or more first layers of the SDM PUSCH communication to a first TRP and the one or more second layers of the SDM PUSCH communication to the second TRP. The UE 120 may transmit the one or more first layers of the SDM PUSCH communication in a first spatial direction, and may transmit the one or more second layers of the SDM PUSCH communication to the second TRP in a second spatial direction.

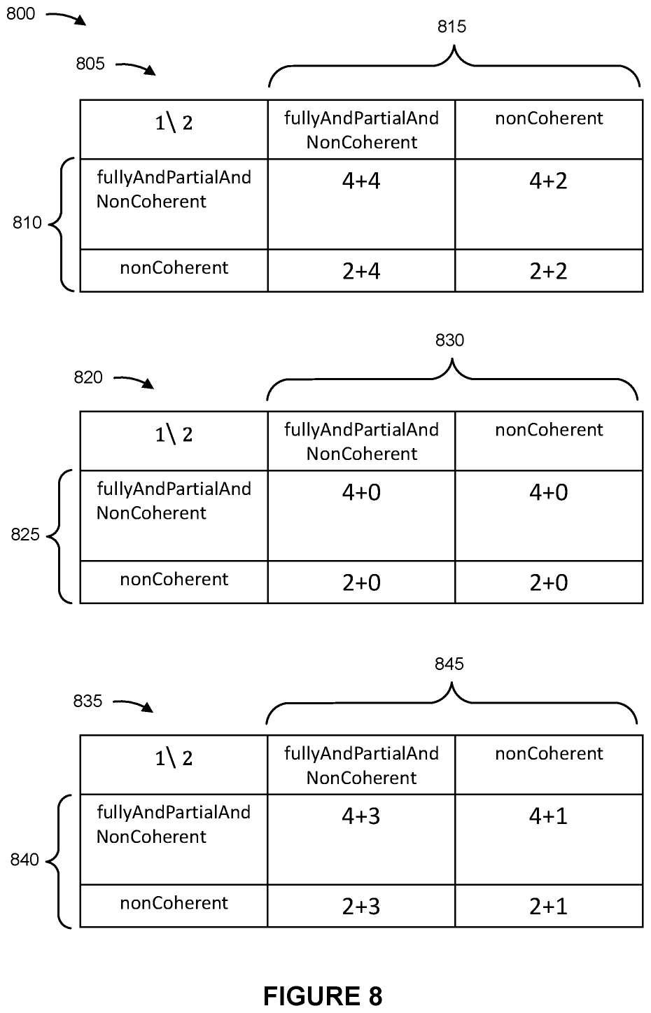

FIG. 8 illustrates a plurality of examples 800 of TPMI field sizes, where the TPMI field sizes are based at least in part on one or more parameters described herein. The plurality of examples 800 includes a plurality of tables indicating TPMI field size combinations for the first TPMI field and the second TPMI field for mTRP (SDM). Other example tables may be used to indicate TPMI field sizes for mTRP (SDM). The UE 120 may determine the size of the first TPMI field, the second TPMI field, or a combination thereof based at least in part on the example tables illustrated in FIG. 8. However, the UE 120 may determine the size of the first TPMI field, the second TPMI field, or a combination thereof based at least in part on other example tables.

Table 805 is an example of TPMI field sizes where the first quantity of the one or more first ports is equal to two (2) and the maximum rank (Lₘₐₓ¹) associated with the first SRS resource set is equal to two (2) (2, Lₘₐₓ¹=2), and where the second quantity of the one or more second ports is equal to two (2) and the maximum rank (Lₘₐₓ²) associated with the second SRS resource set is equal to two (2) (2, Lₘₐₓ²=2). As shown in the table 805, the rows 810 are based on whether the one or more first ports are permitted to be non-coherent, fully coherent, partially coherent, or a combination thereof. As further shown in the table 805, the columns 815 are based on whether the one or more second ports are permitted to be non-coherent, fully coherent, partially coherent, or a combination thereof. Moreover, fullpowerMode1 is not configured for the UE 120 in this example.

If the one or more first ports and the one or more second ports are each permitted to be non-coherent, fully coherent, or partially coherent, the quantity of bits included in the first TPMI field is equal to four (4) bits and the quantity of bits included in the second TPMI field is also equal to four (4) bits (4+4). If the one or more first ports are permitted to be non-coherent, fully coherent, or partially coherent, and the one or more second ports are only permitted to be non-coherent, the quantity of bits included in the first TPMI field is equal to four (4) bits and the quantity of bits included in the second TPMI field is equal to two (2) bits (4+2). If the one or more first ports are only permitted to be non-coherent, and the one or more second ports are permitted to be non-coherent, fully coherent, or partially coherent, the quantity of bits included in the first TPMI field is equal to two (2) bits and the quantity of bits included in the second TPMI field is equal to four (4) bits (2+4). If the one or more first ports and the one or more second ports are each permitted to be only non-coherent, the quantity of bits included in the first TPMI field is equal to two (2) bits and the quantity of bits included in the second TPMI field is also equal to two (2) bits (2+2).

Table 820 is another example of TPMI field sizes where the first quantity of the one or more first ports is equal to two (2) and the maximum rank (Lₘₐₓ¹) associated with the first SRS resource set is equal to one (2) (2, Lₘₐₓ¹=2), and where the second quantity of the one or more second ports is equal to one (1) and the maximum rank (Lₘₐₓ²) associated with the second SRS resource set is equal to one (1) (1, Lₘₐₓ²=1). As shown in the table 820, the rows 825 are based on whether the one or more first ports are permitted to be non-coherent, fully coherent, partially coherent, or a combination thereof. As further shown in the table 820, the columns 830 are based on whether the one or more second ports are permitted to be non-coherent, fully coherent, partially coherent, or a combination thereof. Moreover, fullpowerMode1 is not configured for the UE 120 in this example.

If the one or more first ports and the one or more second ports are each permitted to be non-coherent, fully coherent, or partially coherent, the quantity of bits included in the first TPMI field is equal to four (4) bits and the quantity of bits included in the second TPMI field is also equal to zero (0) bits (4+0). If the one or more first ports are permitted to be non-coherent, fully coherent, or partially coherent, and the one or more second ports are only permitted to be non-coherent, the quantity of bits included in the first TPMI field is equal to four (4) bits and the quantity of bits included in the second TPMI field is equal to zero (0) bits (4+0). If the one or more first ports are only permitted to be non-coherent, and the one or more second ports are permitted to be non-coherent, fully coherent, or partially coherent, the quantity of bits included in the first TPMI field is equal to two (2) bits and the quantity of bits included in the second TPMI field is equal to zero (0) bits (2+0). If the one or more first ports and the one or more second ports are each permitted to be only non-coherent, the quantity of bits included in the first TPMI field is equal to two (2) bits and the quantity of bits included in the second TPMI field is also equal to zero (0) bits (2+0).

Table 835 is another example of TPMI field sizes where the first quantity of the one or more first ports is equal to two (2) and the maximum rank (Lₘₐₓ¹) associated with the first SRS resource set is equal to two (2) (2, Lₘₐₓ¹=2), and where the second quantity of the one or more second ports is equal to two (2) and the maximum rank (Lₘₐₓ²) associated with the second SRS resource set is equal to one (1) (2, Lₘₐₓ²=1). As shown in the table 835, the rows 840 are based on whether the one or more first ports are permitted to be non-coherent, fully coherent, partially coherent, or a combination thereof. As further shown in the table 835, the columns 845 are based on whether the one or more second ports are permitted to be non-coherent, fully coherent, partially coherent, or a combination thereof. Moreover, fullpowerMode1 is not configured for the UE 120 in this example.

If the one or more first ports and the one or more second ports are each permitted to be non-coherent, fully coherent, or partially coherent, the quantity of bits included in the first TPMI field is equal to four (4) bits and the quantity of bits included in the second TPMI field is equal to three (3) bits (4+3). If the one or more first ports are permitted to be non-coherent, fully coherent, or partially coherent, and the one or more second ports are only permitted to be non-coherent, the quantity of bits included in the first TPMI field is equal to four (4) bits and the quantity of bits included in the second TPMI field is equal to one (1) bit (4+1). If the one or more first ports are only permitted to be non-coherent, and the one or more second ports are permitted to be non-coherent, fully coherent, or partially coherent, the quantity of bits included in the first TPMI field is equal to two (2) bits and the quantity of bits included in the second TPMI field is equal to three (3) bits (2+3). If the one or more first ports and the one or more second ports are each permitted to be only non-coherent, the quantity of bits included in the first TPMI field is equal to two (2) bits and the quantity of bits included in the second TPMI field is also equal to one (1) bit (2+1).

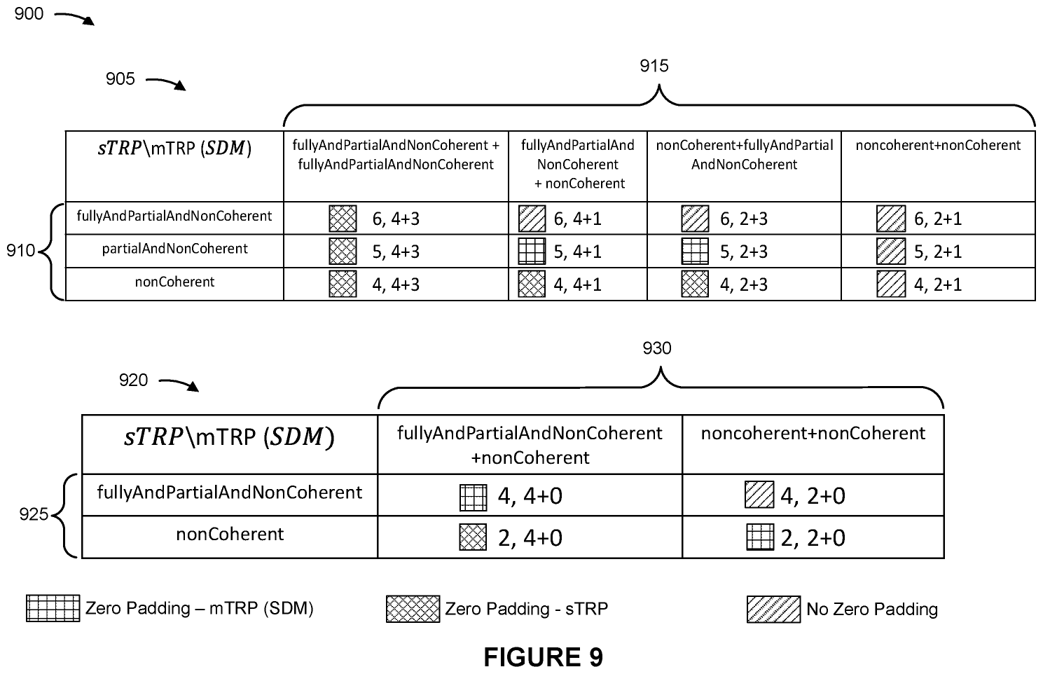

FIG. 9 illustrates a plurality of examples 900 of TPMI field sizes, where the TPMI field sizes are based at least in part on one or more parameters described herein. The plurality of examples 900 includes a plurality of tables indicating TPMI field size combinations for the first TPMI field and the second TPMI field for mTRP (SDM), as well as for sTRP. For sTRP, the first TPMI field and the second TPMI field are combined as a joint TPMI field for sTRP. Other example tables may be used to indicate TPMI field sizes for mTRP (SDM) and sTRP. The UE 120 may determine the size of the first TPMI field, the second TPMI field, the joint TPMI field, or a combination thereof based at least in part on the example tables illustrated in FIG. 9. However, the UE 120 may determine the size of the first TPMI field, the second TPMI field, the joint TPMI field, or a combination thereof based at least in part on other example tables.

Table 905 is an example of TPMI field sizes where the first quantity of the one or more first ports is equal to two (2) and the maximum rank (Lₘₐₓ¹) associated with the first SRS resource set is equal to two (2) (2, Lₘₐₓ¹=2), and where the second quantity of the one or more second ports is equal to two (2) and the maximum rank (Lₘₐₓ²) associated with the second SRS resource set is equal to one (1) (2, Lₘₐₓ²=1). As shown in the table 905, the rows 910 are based on whether the ports for sTRP are permitted to be non-coherent, fully coherent, partially coherent, or a combination thereof. As further shown in the table 905, the columns 915 are based on whether the one or more first ports and the one or more second ports are permitted to be non-coherent, fully coherent, partially coherent, or a combination thereof for mTRP (SDM). Moreover, fullpowerMode1 is not configured for the UE 120 in this example.

For mTRP (SDM) (for example, where the dynamic switching indicator field indicates a ‘10’ value or a ‘11’ value), if the one or more first ports and the one or more second ports are each permitted to be non-coherent, fully coherent, or partially coherent, the quantity of bits included in the first TPMI field is equal to four (4) bits and the quantity of bits included in the second TPMI field is equal to three (3) bits (4+3). For sTRP (for example, where the dynamic switching indicator field indicates a ‘00’ value or a ‘01’ value), a size of a joint TPMI field of the first TPMI field and the second TPMI field is equal to six (6) bits where the ports for sTRP are permitted to be non-coherent, fully coherent, or partially coherent. Zero padding (for example, extra bits that are set or configured to 0-values) is added to the value in the joint TPMI field for sTRP because the combined quantity of bits of the first TPMI field and the second TPMI field is greater relative to the size of the joint TPMI field.

For mTRP (SDM), if the one or more first ports are permitted to be non-coherent, fully coherent, or partially coherent, and the one or more second ports are only permitted to be non-coherent, the quantity of bits included in the first TPMI field is equal to four (4) bits and the quantity of bits included in the second TPMI field is equal to one (1) bit (4+1). For sTRP, a size of a joint TPMI field of the first TPMI field and the second TPMI field is equal to six (6) bits where the ports for sTRP are permitted to be non-coherent, fully coherent, or partially coherent. Zero padding (for example, extra bits that are set or configured to 0-values) is added to the value in one or more of the first TPMI field or the second TPMI field for mTRP (SDM) because the combined quantity of bits of the first TPMI field and the second TPMI field is lesser relative to the size of the joint TPMI field.

For mTRP (SDM), if the one or more first ports are permitted to be only non-coherent, and the one or more second ports are permitted to be non-coherent, fully coherent, or partially coherent, the quantity of bits included in the first TPMI field is equal to two (2) bits and the quantity of bits included in the second TPMI field is equal to three (3) bits (2+3). For sTRP, a size of a joint TPMI field of the first TPMI field and the second TPMI field is equal to six (6) bits where the ports for sTRP are permitted to be non-coherent, fully coherent, or partially coherent. Zero padding (for example, extra bits that are set or configured to 0-values) is added to the value in one or more of the first TPMI field or the second TPMI field for mTRP (SDM) because the combined quantity of bits of the first TPMI field and the second TPMI field is lesser relative to the size of the joint TPMI field.

For mTRP (SDM), if the one or more first ports are permitted to be only non-coherent, and the one or more second ports are permitted to be only non-coherent, the quantity of bits included in the first TPMI field is equal to two (2) bits and the quantity of bits included in the second TPMI field is equal to one (1) bit (2+1). For sTRP, a size of a joint TPMI field of the first TPMI field and the second TPMI field is equal to six (6) bits where the ports for sTRP are permitted to be non-coherent, fully coherent, or partially coherent. Zero padding (for example, extra bits that are set or configured to 0-values) is added to the value in one or more of the first TPMI field or the second TPMI field for mTRP (SDM) because the combined quantity of bits of the first TPMI field and the second TPMI field is lesser relative to the size of the joint TPMI field.

For mTRP (SDM), if the one or more first ports and the one or more second ports are each permitted to be non-coherent, fully coherent, or partially coherent, the quantity of bits included in the first TPMI field is equal to four (4) bits and the quantity of bits included in the second TPMI field is equal to three (3) bits (4+3). For sTRP, a size of a joint TPMI field of the first TPMI field and the second TPMI field is equal to five (5) bits where the ports for sTRP are permitted to be non-coherent or partially coherent. Zero padding (for example, extra bits that are set or configured to 0-values) is added to the value in the joint TPMI field for sTRP because the combined quantity of bits of the first TPMI field and the second TPMI field is greater relative to the size of the joint TPMI field.

For mTRP (SDM), if the one or more first ports are permitted to be non-coherent, fully coherent, or partially coherent, and the one or more second ports are only permitted to be non-coherent, the quantity of bits included in the first TPMI field is equal to four (4) bits and the quantity of bits included in the second TPMI field is equal to one (1) bit (4+1). For sTRP, a size of a joint TPMI field of the first TPMI field and the second TPMI field is equal to five (5) bits where the ports for sTRP are permitted to be non-coherent or partially coherent. Zero padding is not used in this example because the combined quantity of bits of the first TPMI field and the second TPMI field is equal to the size of the joint TPMI field.

For mTRP (SDM), if the one or more first ports are permitted to be only non-coherent, and the one or more second ports are permitted to be non-coherent, fully coherent, or partially coherent, the quantity of bits included in the first TPMI field is equal to two (2) bits and the quantity of bits included in the second TPMI field is equal to three (3) bits (2+3). For sTRP, a size of a joint TPMI field of the first TPMI field and the second TPMI field is equal to five (5) bits where the ports for sTRP are permitted to be non-coherent or partially coherent. Zero padding is not used in this example because the combined quantity of bits of the first TPMI field and the second TPMI field is equal to the size of the joint TPMI field.

For mTRP (SDM), if the one or more first ports are permitted to be only non-coherent, and the one or more second ports are permitted to be only non-coherent, the quantity of bits included in the first TPMI field is equal to two (2) bits and the quantity of bits included in the second TPMI field is equal to one (1) bit (2+1). For sTRP, a size of a joint TPMI field of the first TPMI field and the second TPMI field is equal to five (5) bits where the ports for sTRP are permitted to be non-coherent or partially coherent. Zero padding (for example, extra bits that are set or configured to 0-values) is added to the value in one or more of the first TPMI field or the second TPMI field for mTRP (SDM) because the combined quantity of bits of the first TPMI field and the second TPMI field is lesser relative to the size of the joint TPMI field.

for mTRP (SDM), if the one or more first ports and the one or more second ports are each permitted to be non-coherent, fully coherent, or partially coherent, the quantity of bits included in the first TPMI field is equal to four (4) bits and the quantity of bits included in the second TPMI field is equal to three (3) bits (4+3). For sTRP, a size of a joint TPMI field of the first TPMI field and the second TPMI field is equal to four (4) bits where the ports for sTRP are permitted to be only non-coherent. Zero padding (for example, extra bits that are set or configured to 0-values) is added to the value in the joint TPMI field for sTRP because the combined quantity of bits of the first TPMI field and the second TPMI field is greater relative to the size of the joint TPMI field.

For mTRP (SDM), if the one or more first ports are permitted to be non-coherent, fully coherent, or partially coherent, and the one or more second ports are only permitted to be non-coherent, the quantity of bits included in the first TPMI field is equal to four (4) bits and the quantity of bits included in the second TPMI field is equal to one (1) bit (4+1). For sTRP, a size of a joint TPMI field of the first TPMI field and the second TPMI field is equal to four (4) bits where the ports for sTRP are permitted to be only non-coherent. Zero padding (for example, extra bits that are set or configured to 0-values) is added to the value in the joint TPMI field for sTRP because the combined quantity of bits of the first TPMI field and the second TPMI field is greater relative to the size of the joint TPMI field.

For mTRP (SDM), if the one or more first ports are permitted to be only non-coherent, and the one or more second ports are permitted to be non-coherent, fully coherent, or partially coherent, the quantity of bits included in the first TPMI field is equal to two (2) bits and the quantity of bits included in the second TPMI field is equal to three (3) bits (2+3). For sTRP, a size of a joint TPMI field of the first TPMI field and the second TPMI field is equal to four (4) bits where the ports for sTRP are permitted to be only non-coherent. Zero padding (for example, extra bits that are set or configured to 0-values) is added to the value in the joint TPMI field for sTRP because the combined quantity of bits of the first TPMI field and the second TPMI field is greater relative to the size of the joint TPMI field.

For mTRP (SDM), if the one or more first ports are permitted to be only non-coherent, and the one or more second ports are permitted to be only non-coherent, the quantity of bits included in the first TPMI field is equal to two (2) bits and the quantity of bits included in the second TPMI field is equal to one (1) bit (2+1). For sTRP, a size of a joint TPMI field of the first TPMI field and the second TPMI field is equal to four (4) bits where the ports for sTRP are permitted to be only non-coherent. Zero padding (for example, extra bits that are set or configured to 0-values) is added to the value in one or more of the first TPMI field or the second TPMI field for mTRP (SDM) because the combined quantity of bits of the first TPMI field and the second TPMI field is lesser relative to the size of the joint TPMI field.

Table 920 is an example of TPMI field sizes where the first quantity of the one or more first ports is equal to two (2) and the maximum rank (Lₘₐₓ¹) associated with the first SRS resource set is equal to two (2) (2, Lₘₐₓ¹=2), and where the second quantity of the one or more second ports is equal to one (1) and the maximum rank (Lₘₐₓ²) associated with the second SRS resource set is equal to one (1) (2, Lₘₐₓ²=1). As shown in the table 920, the rows 925 are based on whether the ports for sTRP are permitted to be non-coherent, fully coherent, partially coherent, or a combination thereof. As further shown in the table 920, the columns 930 are based on whether the one or more first ports and the one or more second ports are permitted to be non-coherent, fully coherent, partially coherent, or a combination thereof for mTRP (SDM). Moreover, fullpowerMode1 is not configured for the UE 120 in this example.

For mTRP (SDM), if the one or more first ports are permitted to be non-coherent, fully coherent, or partially coherent, and the one or more second ports are permitted to be only non-coherent, the quantity of bits included in the first TPMI field is equal to four (4) bits and the quantity of bits included in the second TPMI field is equal to zero (0) bits (4+0). For sTRP, a size of a joint TPMI field of the first TPMI field and the second TPMI field is equal to four (4) bits where the ports for sTRP are permitted to be non-coherent, fully coherent, or partially coherent. Zero padding is not used in this example because the combined quantity of bits of the first TPMI field and the second TPMI field is equal to the size of the joint TPMI field.

For mTRP (SDM), if the one or more first ports are permitted to be only non-coherent, and the one or more second ports are permitted to be only non-coherent, the quantity of bits included in the first TPMI field is equal to two (2) bits and the quantity of bits included in the second TPMI field is equal to zero (0) bits (2+0). For sTRP, a size of a joint TPMI field of the first TPMI field and the second TPMI field is equal to four (4) bits where the ports for sTRP are permitted to be non-coherent, fully coherent, or partially coherent. Zero padding (for example, extra bits that are set or configured to 0-values) is added to the value in one or more of the first TPMI field or the second TPMI field for mTRP (SDM) because the combined quantity of bits of the first TPMI field and the second TPMI field is lesser relative to the size of the joint TPMI field.

For mTRP (SDM), if the one or more first ports are permitted to be non-coherent, fully coherent, or partially coherent, and the one or more second ports are permitted to be only non-coherent, the quantity of bits included in the first TPMI field is equal to four (4) bits and the quantity of bits included in the second TPMI field is equal to zero (0) bits (4+0). For sTRP, a size of a joint TPMI field of the first TPMI field and the second TPMI field is equal to two (2) bits where the ports for sTRP are permitted to be only non-coherent. Zero padding (for example, extra bits that are set or configured to 0-values) is added to the value in the joint TPMI field for sTRP because the combined quantity of bits of the first TPMI field and the second TPMI field is greater relative to the size of the joint TPMI field.

For mTRP (SDM), if the one or more first ports are permitted to be only non-coherent, and the one or more second ports are permitted to be only non-coherent, the quantity of bits included in the first TPMI field is equal to two (2) bits and the quantity of bits included in the second TPMI field is equal to zero (0) bits (2+0). For sTRP, a size of a joint TPMI field of the first TPMI field and the second TPMI field is equal to two (0) bits where the ports for sTRP are permitted to be only non-coherent. Zero padding is not used in this example because the combined quantity of bits of the first TPMI field and the second TPMI field is equal to the size of the joint TPMI field.

FIG. 10 is a flowchart illustrating an example process 1000 performed, for example, by a UE in accordance with the present disclosure. Example process 1000 is an example where the UE (for example, UE 120) performs operations associated with SRI and TPMI signaling for uplink SDM.

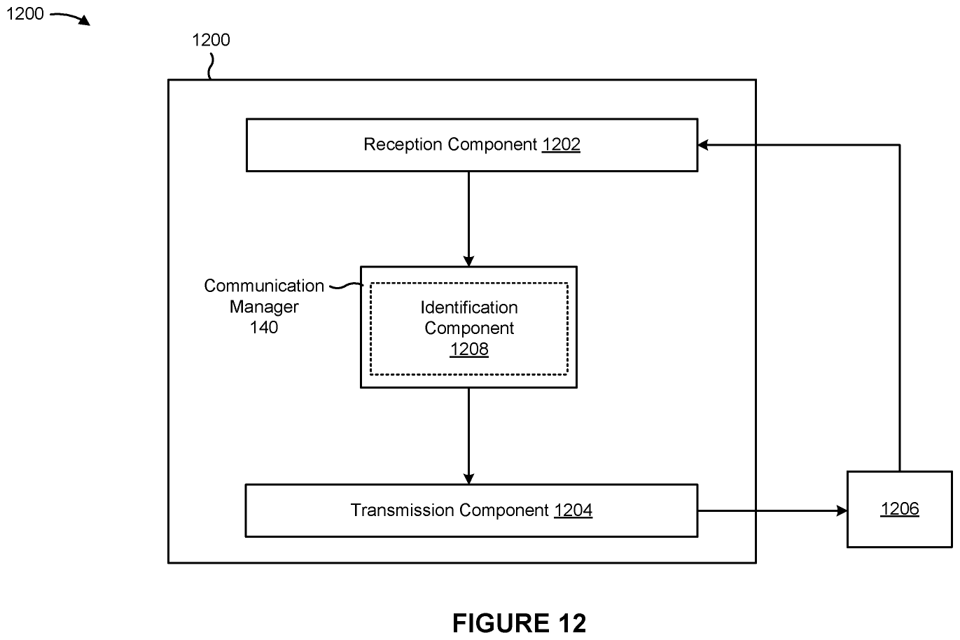

As shown in FIG. 10, in some aspects, process 1000 may include receiving configuration information associated with a first SRS resource set and a second SRS resource set (block 1010). For example, the UE (such as by using communication manager 140 or reception component 1202, depicted in FIG. 12) may receive configuration information associated with a first SRS resource set and a second SRS resource set, as described above.

As further shown in FIG. 10, in some aspects, process 1000 may include receiving DCI that schedules an SDM PUSCH communication, the DCI including a first SRI field associated with the first SRS resource set that indicates one or more first transmission parameters for one or more first layers of the SDM PUSCH communication, a first TPMI field that indicates one or more first precoding parameters for the one or more first layers, a second SRI field associated with the second SRS resource set that indicates a one or more second transmission parameters for one or more second layers of the SDM PUSCH communication, and a second TPMI field that indicates one or more second precoding parameters for the one or more second layers (block 1020). For example, the UE (such as by using communication manager 140 or reception component 1202, depicted in FIG. 12) may receive DCI that schedules an SDM PUSCH communication, the DCI including a first SRI field associated with the first SRS resource set that indicates one or more first transmission parameters for one or more first layers of the SDM PUSCH communication, a first transmit precoder matrix index (TPMI) field that indicates one or more first precoding parameters for the one or more first layers, a second SRI field associated with the second SRS resource set that indicates a one or more second transmission parameters for one or more second layers of the SDM PUSCH communication, and a second TPMI field that indicates one or more second precoding parameters for the one or more second layers, as described above.

Process 1000 may include additional aspects, such as any single aspect or any combination of aspects described below or in connection with one or more other processes described elsewhere herein.

In a first additional aspect, the one or more first transmission parameters include at least one of one or more beams for the one or more first layers or one or more power control parameters for the one or more first layers, and the one or more first precoding parameters include at least one of a codebook-based precoder index or a quantity of layers for the one or more first layers.

In a second additional aspect, alone or in combination with the first aspect, process 1000 includes identifying a precoder matrix, for precoding the one or more first layers, based at least in part on a maximum rank associated with the first SRS resource set and a quantity of ports associated with an SRS resource, of the first SRS resource set, indicated by the first SRI field.

In a third additional aspect, alone or in combination with one or more of the first and second aspects, process 1000 includes identifying the maximum rank associated with the first SRS resource set based at least in part on at least one of a radio resource control (RRC) configuration, a configuration at the UE, or a combined maximum rank for the first SRS resource set and the second SRS resource set.

In a fourth additional aspect, alone or in combination with one or more of the first through third aspects, identifying the precoder matrix includes identifying a first table based at least in part on the maximum rank and the quantity of antenna ports, identifying a TPMI index and a quantity of layers based at least in part on an association in the first table between the TPMI index, the quantity of layers, and a bit field index indicated by the first TPMI field, identifying a second table based at least in part on the quantity of layers and the quantity of ports, and identifying the precoder matrix in the second table based at least in part on the TPMI index.

In a fifth additional aspect, alone or in combination with one or more of the first through fourth aspects, a quantity of bits included in the first TPMI field is based at least in part on at least one of a maximum rank associated with the first SRS resource set, a first quantity of one or more first ports associated with a first SRS resource of the first SRS resource set indicated by the first SRI field, a coherency of the one or more first ports associated with the first SRS resource and one or more second ports associated with a second SRS resource of the second SRS resource set indicated by the second SRI field, or whether fullpowerMode1 is configured.

In a sixth additional aspect, alone or in combination with one or more of the first through fifth aspects, the quantity of the one or more first ports and a quantity of the one or more second ports are a same quantity.

In a seventh additional aspect, alone or in combination with one or more of the first through sixth aspects, the quantity of the one or more first ports and a quantity of the one or more second ports are different quantities.

In an eighth additional aspect, alone or in combination with one or more of the first through seventh aspects, the quantity of bits included in the first TPMI field is based at least in part on a first maximum quantity of ports for the first SRS resource set, and the quantity of bits included in the second TPMI field is based at least in part on a second maximum quantity of ports for the second SRS resource set with zero padding.

In a ninth additional aspect, alone or in combination with one or more of the first through eighth aspects, the DCI includes a dynamic switching indicator field that indicates that the first SRI field, the second SRI field, the first TPMI field, and the second TPMI field are associated with a single TRP, the one or more first transmission parameters and the one or more second transmission parameters are a same one or more transmission parameters, the same one or more transmission parameters being indicated in the DCI by a joint SRI field that includes the first SRI field and the second SRI field, and the one or more first precoding parameters and the one or more second precoding parameters are a same one or more precoding parameters, the same one or more precoding parameters being indicated in the DCI by a joint TPMI field including the first TPMI field and the second TPMI field.

In a tenth additional aspect, alone or in combination with one or more of the first through ninth aspects, a quantity of bits included in the joint TPMI field is based at least in part on a maximum rank for the single TRP and a quantity of ports for the single TRP.

In an eleventh additional aspect, alone or in combination with one or more of the first through tenth aspects, the maximum rank for the single TRP is equal to or less than a maximum rank associated with the first SRS resource set or a maximum rank associated with the second SRS resource set, or the maximum rank for the single TRP is equal to or less than a lesser quantity of either a default rank or a combination of the maximum rank associated with the first SRS resource set and the maximum rank associated with the second SRS resource set.

In a twelfth additional aspect, alone or in combination with one or more of the first through eleventh aspects, the quantity of ports for the single TRP is equal to or less than a quantity of ports for the first SRS resource set or a quantity of ports for the second SRS resource set, or the quantity of ports for the single TRP is equal to or less than a lesser quantity of either a default quantity of ports or a combination of the quantity of ports for the first SRS resource set and the quantity of ports for the second SRS resource set.

In a thirteenth additional aspect, alone or in combination with one or more of the first through twelfth aspects, an overall quantity of bits included in the DCI for the first TPMI field and the second TPMI field, for supporting dynamic switching between sTRP communication and mTRP communication, corresponds to a greater quantity of a first quantity of bits for sTRP communication or a second quantity of bits for mTRP communication.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a flowchart illustrating an example process 1100 performed, for example, by a base station in accordance with the present disclosure. Example process 1100 is an example where the base station (for example, base station 110) performs operations associated with SRI and TPMI signaling for uplink SDM.

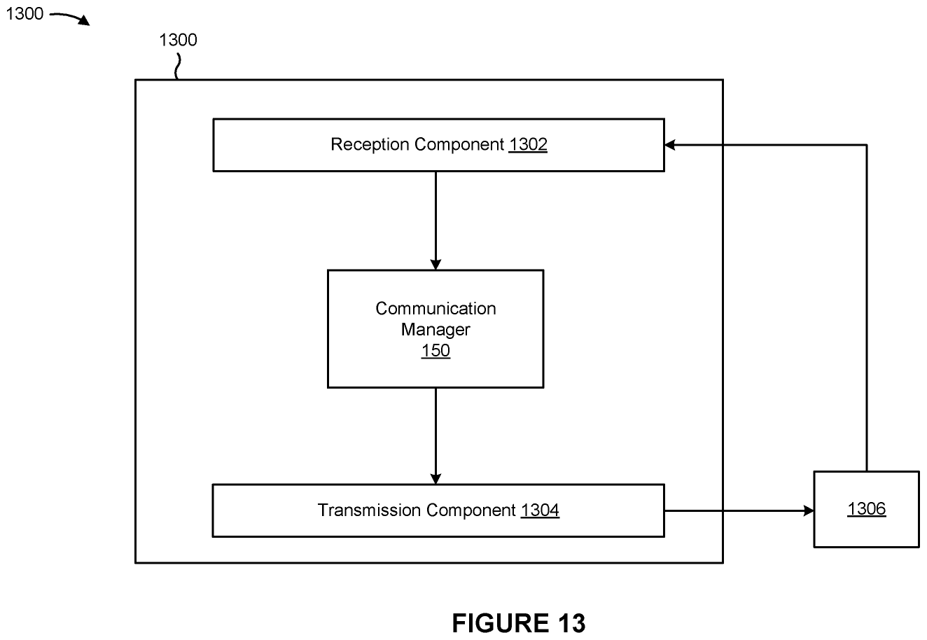

As shown in FIG. 11, in some aspects, process 1100 may include transmitting configuration information associated with a first SRS resource set and a second SRS resource set (block 1110). For example, the base station (such as by using communication manager 150 or transmission component 1304, depicted in FIG. 13) may transmit configuration information associated with a first SRS resource set and a second SRS resource set, as described above.

As further shown in FIG. 11, in some aspects, process 1100 may include transmitting DCI that schedules an SDM PUSCH communication, the DCI including: a first SRI field associated with the first SRS resource set that indicates one or more first transmission parameters for one or more first layers of the SDM PUSCH communication, a first TPMI field indicating one or more first precoding parameters for the one or more first layers, a second SRI field associated with the second SRS resource set that indicates one or more second transmission parameters for one or more second layers of the SDM PUSCH communication, and a second TPMI field indicating one or more second precoding parameters for the one or second more layers (block 1120). For example, the base station (such as by using communication manager 150 or transmission component 1304, depicted in FIG. 13) may transmit DCI that schedules an SDM PUSCH communication, the DCI including a first SRI field associated with the first SRS resource set that indicates one or more first transmission parameters for one or more first layers of the SDM PUSCH communication, a first TPMI field indicating one or more first precoding parameters for the one or more first layers, a second SRI field associated with the second SRS resource set that indicates one or more second transmission parameters for one or more second layers of the SDM PUSCH communication, and a second TPMI field indicating one or more second precoding parameters for the one or second more layers, as described above.

Process 1100 may include additional aspects, such as any single aspect or any combination of aspects described below or in connection with one or more other processes described elsewhere herein.

In a first additional aspect, the one or more first transmission parameters include at least one of one or more beams for the one or more first layers or one or more power control parameters for the one or more first layers, and wherein the one or more first precoding parameters include at least one of a codebook-based precoder index or a quantity of layers for the one or more first layers.

In a second additional aspect, alone or in combination with the first aspect, a quantity of bits included in the first TPMI field is based at least in part on at least one of a maximum rank associated with the first SRS resource set, a first quantity of one or more first ports associated with a first SRS resource of the first SRS resource set indicated by the first SRI field, a coherency of the one or more first ports associated with the first SRS resource and one or more second ports associated with a second SRS resource of the second SRS resource set indicated by the second SRI field, or whether fullpowerMode1 is configured.

In a third additional aspect, alone or in combination with one or more of the first and second aspects, the quantity of the one or more first ports and a quantity of the one or more second ports are a same quantity.

In a fourth additional aspect, alone or in combination with one or more of the first through third aspects, the quantity of the one or more first ports and a quantity of the one or more second ports are different quantities.

In a fifth additional aspect, alone or in combination with one or more of the first through fourth aspects, the quantity of bits included in the first TPMI field is based at least in part on a first maximum quantity of ports for the first SRS resource set, and the quantity of bits included in the second TPMI field is based at least in part on a second maximum quantity of ports for the second SRS resource set with zero padding.

In a sixth additional aspect, alone or in combination with one or more of the first through fifth aspects, the DCI includes a dynamic switching indicator field that indicates that the first SRI field, the second SRI field, the first TPMI field, and the second TPMI field are associated with a single TRP, the one or more first transmission parameters and the one or more transmission second parameters are a same one or more transmission parameters, the same one or more transmission parameters being indicated in the DCI by a joint SRI field including the first SRI field and the second SRI field, and the one or more first precoding parameters and the one or more second precoding parameters are a same one or more precoding parameters, the same one or more precoding parameters being indicated in the DCI by a joint TPMI field including the first TPMI field and the second TPMI field.

In a seventh additional aspect, alone or in combination with one or more of the first through sixth aspects, a quantity of bits included in the joint TPMI field is based at least in part on a maximum rank for the single TRP and a quantity of ports for the single TRP.

In an eighth additional aspect, alone or in combination with one or more of the first through seventh aspects, the maximum rank for the single TRP is equal to or less than a maximum rank associated with the first SRS resource set or a maximum rank associated with the second SRS resource set, or the maximum rank for the single TRP is equal to or less than a lesser quantity of either a default rank or a combination of the maximum rank associated with the first SRS resource set and the maximum rank associated with the second SRS resource set.

In a ninth additional aspect, alone or in combination with one or more of the first through eighth aspects, the quantity of ports for the single TRP is equal to or less than a quantity of ports for the first SRS resource set or a quantity of ports for the second SRS resource set, or the quantity of ports for the single TRP is equal to or less than a lesser quantity of either a default quantity of ports or a combination of the quantity of ports for the first SRS resource set and the quantity of ports for the second SRS resource set.

In a tenth additional aspect, alone or in combination with one or more of the first through ninth aspects, an overall quantity of bits included in the DCI for the first TPMI field and the second TPMI field, for supporting dynamic switching between sTRP communication and mTRP communication, corresponds to a greater quantity of a first quantity of bits for sTRP communication or a second quantity of bits for mTRP communication.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a diagram of an example apparatus 1200 for wireless communication in accordance with the present disclosure. The apparatus 1200 may be a UE 120, or a UE 120 may include the apparatus 1200. In some aspects, the apparatus 1200 includes a reception component 1202, a transmission component 1204, and a communication manager 140, which may be in communication with one another (for example, via one or more buses). As shown, the apparatus 1200 may communicate with another apparatus 1206 (such as a UE, a base station, or another wireless communication device) using the reception component 1202 and the transmission component 1204.

In some aspects, the apparatus 1200 may be configured to perform one or more operations described herein in connection with FIGS. 3-9. Additionally or alternatively, the apparatus 1200 may be configured to perform one or more processes described herein, such as process 1000 of FIG. 10. In some aspects, the apparatus 1200 may include one or more components of the UE 120 described above in connection with FIG. 2.

The reception component 1202 may receive communications, such as reference signals, control information, data communications, or a combination thereof, from the apparatus 1206. The reception component 1202 may provide received communications to one or more other components of the apparatus 1200, such as the communication manager 140. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1202 may include one or more antennas, a modem, a demodulator, a MIMO detector, a receive processor, a controller/processor, a memory, or a combination thereof, of the UE 120 described above in connection with FIG. 2.

The transmission component 1204 may transmit communications, such as reference signals, control information, data communications, or a combination thereof, to the apparatus 1206. In some aspects, the communication manager 140 may generate communications and may transmit the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE 120 described above in connection with FIG. 2. In some aspects, the transmission component 1204 may be co-located with the reception component 1202 in a transceiver.

The communication manager 140 may receive or may cause (for example, from the apparatus 1206) the reception component 1202 to receive configuration information associated with a first SRS resource set and a second SRS resource set. The communication manager 140 may receive (for example, from the apparatus 1206) or may cause the reception component 1202 to receive DCI that schedules an SDM PUSCH communication, the DCI including a first SRI field associated with the first SRS resource set that indicates one or more first transmission parameters for one or more first layers of the SDM PUSCH communication, a first TPMI field that indicates one or more first precoding parameters for the one or more first layers, a second SRI field associated with the second SRS resource set that indicates a one or more second transmission parameters for one or more second layers of the SDM PUSCH communication, and a second TPMI field that indicates one or more second precoding parameters for the one or more second layers. In some aspects, the communication manager 140 may perform one or more operations described elsewhere herein as being performed by one or more components of the communication manager 140.

The communication manager 140 may include a controller/processor, a memory, or a combination thereof, of the UE 120 described above in connection with FIG. 2. In some aspects, the communication manager 140 includes a set of components, such as an identification component 1208. Alternatively, the set of components may be separate and distinct from the communication manager 140. In some aspects, one or more components of the set of components may include or may be implemented within a controller/processor, a memory, or a combination thereof, of the UE 120 described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive configuration information associated with a SRS resource set and a second SRS resource set. The reception component 1202 may receive DCI that schedules a SDM PUSCH communication, the DCI including a first SRI field associated with the first SRS resource set that indicates one or more first transmission parameters for one or more first layers of the SDM PUSCH communication, a first TPMI field that indicates one or more first precoding parameters for the one or more first layers, a second SRI field associated with the second SRS resource set that indicates a one or more second transmission parameters for one or more second layers of the SDM PUSCH communication, and a second TPMI field that indicates one or more second precoding parameters for the one or more second layers.

The identification component 1208 may identify a precoder matrix, for precoding the one or more first layers, based at least in part on a maximum rank associated with the first SRS resource set and a quantity of ports associated with an SRS resource, of the first SRS resource set, indicated by the first SRI field.

The identification component 1208 may identify the maximum rank associated with the first SRS resource set based at least in part on at least one of an RRC configuration, a configuration at the UE, or a combined maximum rank for the first SRS resource set and the second SRS resource set.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

FIG. 13 is a diagram of an example apparatus 1300 for wireless communication in accordance with the present disclosure. The apparatus 1300 may be a base station 110, or a base station 110 may include the apparatus 1300. In some aspects, the apparatus 1300 includes a reception component 1302, a transmission component 1304, and a communication manager 150, which may be in communication with one another (for example, via one or more buses). As shown, the apparatus 1300 may communicate with another apparatus 1306 (such as a UE, a base station, or another wireless communication device) using the reception component 1302 and the transmission component 1304.

In some aspects, the apparatus 1300 may be configured to perform one or more operations described herein in connection with FIGS. 3-9. Additionally or alternatively, the apparatus 1300 may be configured to perform one or more processes described herein, such as process 1100 of FIG. 11, or a combination thereof. In some aspects, the apparatus 1300 may include one or more components of the base station 110 described above in connection with FIG. 2.

The reception component 1302 may receive communications, such as reference signals, control information, data communications, or a combination thereof, from the apparatus 1306. The reception component 1302 may provide received communications to one or more other components of the apparatus 1300, such as the communication manager 150. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1302 may include one or more antennas, a modem, a demodulator, a MIMO detector, a receive processor, a controller/processor, a memory, or a combination thereof, of the base station 110 described above in connection with FIG. 2.

The transmission component 1304 may transmit communications, such as reference signals, control information, data communications, or a combination thereof, to the apparatus 1306. In some aspects, the communication manager 150 may generate communications and may transmit the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the base station 110 described above in connection with FIG. 2. In some aspects, the transmission component 1304 may be co-located with the reception component 1302 in a transceiver.

The communication manager 150 may transmit (for example, to the apparatus 1306) or may cause the transmission component 1304 to transmit configuration information associated with a first SRS resource set and a second SRS resource set. The communication manager 150 may transmit (for example, to the apparatus 1306) or may cause the transmission component 1304 to transmit DCI that schedules an SDM PUSCH communication, the DCI including a first SRI field associated with the first SRS resource set that indicates one or more first transmission parameters for one or more first layers of the SDM PUSCH communication, a first TPMI field indicating one or more first precoding parameters for the one or more first layers, a second SRI field associated with the second SRS resource set that indicates one or more second transmission parameters for one or more second layers of the SDM PUSCH communication, and a second TPMI field indicating one or more second precoding parameters for the one or second more layers. In some aspects, the communication manager 150 may perform one or more operations described elsewhere herein as being performed by one or more components of the communication manager 150.

The communication manager 150 may include a controller/processor, a memory, a scheduler, a communication unit, or a combination thereof, of the base station 110 described above in connection with FIG. 2. In some aspects, the communication manager 150 includes a set of components. Alternatively, the set of components may be separate and distinct from the communication manager 150. In some aspects, one or more components of the set of components may include or may be implemented within a controller/processor, a memory, a scheduler, a communication unit, or a combination thereof, of the base station 110 described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 1304 may transmit configuration information associated with a first SRS resource set and a second SRS resource set. The transmission component 1304 may transmit DCI that schedules an SDM PUSCH communication, the DCI including a first SRI field associated with the first SRS resource set that indicates one or more first transmission parameters for one or more first layers of the SDM PUSCH communication, a first TPMI field indicating one or more first precoding parameters for the one or more first layers, a second SRI field associated with the second SRS resource set that indicates one or more second transmission parameters for one or more second layers of the SDM PUSCH communication, and a second TPMI field indicating one or more second precoding parameters for the one or second more layers.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving configuration information associated with a first sounding reference signal (SRS) resource set and a second SRS resource set; and receiving downlink control information (DCI) that schedules a spatial division multiplexing (SDM) physical uplink shared channel (PUSCH) communication, the DCI including: a first SRS resource indicator (SRI) field associated with the first SRS resource set that indicates one or more first transmission parameters for one or more first layers of the SDM PUSCH communication, a first transmit precoder matrix index (TPMI) field that indicates one or more first precoding parameters for the one or more first layers, a second SRI field associated with the second SRS resource set that indicates a one or more second transmission parameters for one or more second layers of the SDM PUSCH communication, and a second TPMI field that indicates one or more second precoding parameters for the one or more second layers.

Aspect 2: The method of Aspect 1, wherein the one or more first transmission parameters comprise at least one of: one or more beams for the one or more first layers or one or more power control parameters for the one or more first layers, and wherein the one or more first precoding parameters comprise at least one of: a codebook-based precoder index or a quantity of layers for the one or more first layers.

Aspect 3: The method of Aspect 1 or 2, further comprising identifying a precoder matrix, for precoding the one or more first layers, based at least in part on a maximum rank associated with the first SRS resource set and a quantity of ports associated with an SRS resource, of the first SRS resource set, indicated by the first SRI

### FIELD

Aspect 4: The method of Aspect 3, further comprising identifying the maximum rank associated with the first SRS resource set based at least in part on at least one of: a radio resource control (RRC) configuration, a configuration at the UE, or a combined maximum rank for the first SRS resource set and the second SRS resource set.

Aspect 5: The method of Aspect 3 or 4, wherein identifying the precoder matrix comprises: identifying a first table based at least in part on the maximum rank and the quantity of antenna ports, identifying a TPMI index and a quantity of layers based at least in part on an association in the first table between the TPMI index, the quantity of layers, and a bit field index indicated by the first TPMI field, identifying a second table based at least in part on the quantity of layers and the quantity of ports, and identifying the precoder matrix in the second table based at least in part on the TPMI index.

Aspect 6: The method of one or more of Aspects 1-5, wherein a quantity of bits included in the first TPMI field is based at least in part on at least one of: a maximum rank associated with the first SRS resource set, a first quantity of one or more first ports associated with a first SRS resource of the first SRS resource set indicated by the first SRI field, a coherency of the one or more first ports associated with the first SRS resource and one or more second ports associated with a second SRS resource of the second SRS resource set indicated by the second SRI field, or whether fullpowerMode1 is configured.

Aspect 7: The method of Aspect 6, wherein the quantity of the one or more first ports and a quantity of the one or more second ports are a same quantity.

Aspect 8: The method of Aspect 6 or 7, wherein the quantity of the one or more first ports and a quantity of the one or more second ports are different quantities.

Aspect 9: The method of one or more of Aspects 6-8, wherein the quantity of bits included in the first TPMI field is based at least in part on a first maximum quantity of ports for the first SRS resource set, and wherein the quantity of bits included in the second TPMI field is based at least in part on a second maximum quantity of ports for the second SRS resource set with zero padding.

Aspect 10: The method of one or more of Aspects 1-9, wherein the DCI includes a dynamic switching indicator field that indicates that the first SRI field, the second SRI field, the first TPMI field, and the second TPMI field are associated with a single transmit receive point (TRP), wherein the one or more first transmission parameters and the one or more second transmission parameters are a same one or more transmission parameters, the same one or more transmission parameters being indicated in the DCI by a joint SRI field that includes the first SRI field and the second SRI field, and wherein the one or more first precoding parameters and the one or more second precoding parameters are a same one or more precoding parameters, the same one or more precoding parameters being indicated in the DCI by a joint TPMI field including the first TPMI field and the second TPMI field.

Aspect 11: The method of Aspect 10, wherein a quantity of bits included in the joint TPMI field is based at least in part on a maximum rank for the single TRP and a quantity of ports for the single TRP.

Aspect 12: The method of Aspect 11, wherein the maximum rank for the single TRP is equal to or less than a maximum rank associated with the first SRS resource set or a maximum rank associated with the second SRS resource set, or wherein the maximum rank for the single TRP is equal to or less than a lesser quantity of either a default rank or a combination of the maximum rank associated with the first SRS resource set and the maximum rank associated with the second SRS resource set.

Aspect 13: The method of Aspect 11 or 12, wherein the quantity of ports for the single TRP is equal to or less than a quantity of ports for the first SRS resource set or a quantity of ports for the second SRS resource set, or wherein the quantity of ports for the single TRP is equal to or less than a lesser quantity of either a default quantity of ports or a combination of the quantity of ports for the first SRS resource set and the quantity of ports for the second SRS resource set.

Aspect 14: The method of one or more of Aspects 1-13, wherein an overall quantity of bits included in the DCI for the first TPMI field and the second TPMI field, for supporting dynamic switching between single transmit receive point (sTRP) communication and multiple transmit receive point (mTRP) communication, corresponds to a greater quantity of a first quantity of bits for sTRP communication or a second quantity of bits for mTRP communication.

Aspect 15: A method of wireless communication performed by a base station, comprising: transmitting configuration information associated with a first sounding reference signal (SRS) resource set and a second SRS resource set; and transmitting downlink control information (DCI) that schedules a spatial division multiplexing (SDM) physical uplink shared channel (PUSCH) communication, the DCI including: a first SRS resource indicator (SRI) field associated with the first SRS resource set that indicates one or more first transmission parameters for one or more first layers of the SDM PUSCH communication, a first transmit precoder matrix index (TPMI) field indicating one or more first precoding parameters for the one or more first layers, a second SRI field associated with the second SRS resource set that indicates one or more second transmission parameters for one or more second layers of the SDM PUSCH communication, and a second TPMI field indicating one or more second precoding parameters for the one or second more layers.

Aspect 16: The method of Aspect 15, wherein the one or more first transmission parameters comprise at least one of: one or more beams for the one or more first layers or one or more power control parameters for the one or more first layers, and wherein the one or more first precoding parameters comprise at least one of: a codebook-based precoder index or a quantity of layers for the one or more first layers.

Aspect 17: The method of Aspect 15 or 16, wherein a quantity of bits included in the first TPMI field is based at least in part on at least one of: a maximum rank associated with the first SRS resource set, a first quantity of one or more first ports associated with a first SRS resource of the first SRS resource set indicated by the first SRI field, a coherency of the one or more first ports associated with the first SRS resource and one or more second ports associated with a second SRS resource of the second SRS resource set indicated by the second SRI field, or whether fullpowerMode1 is configured.

Aspect 18: The method of Aspect 17, wherein the quantity of the one or more first ports and a quantity of the one or more second ports are a same quantity.

Aspect 19: The method of Aspect 17 or 18, wherein the quantity of the one or more first ports and a quantity of the one or more second ports are different quantities.

Aspect 20: The method of one or more of Aspects 17-19, wherein the quantity of bits included in the first TPMI field is based at least in part on a first maximum quantity of ports for the first SRS resource set, and wherein the quantity of bits included in the second TPMI field is based at least in part on a second maximum quantity of ports for the second SRS resource set with zero padding.

Aspect 21: The method of one or more of Aspects 15-20, wherein the DCI includes a dynamic switching indicator field that indicates that the first SRI field, the second SRI field, the first TPMI field, and the second TPMI field are associated with a single transmit receive point (TRP), wherein the one or more first transmission parameters and the one or more second transmission parameters are a same one or more transmission parameters, the same one or more transmission parameters being indicated in the DCI by a joint SRI field including the first SRI field and the second SRI field, and wherein the one or more first precoding parameters and the one or more second precoding parameters are a same one or more precoding parameters, the same one or more precoding parameters being indicated in the DCI by a joint TPMI field including the first TPMI field and the second TPMI field.

Aspect 22: The method of Aspect 21, wherein a quantity of bits included in the joint TPMI field is based at least in part on a maximum rank for the single TRP and a quantity of ports for the single TRP.

Aspect 23: The method of Aspect 22, wherein the maximum rank for the single TRP is equal to or less than a maximum rank associated with the first SRS resource set or a maximum rank associated with the second SRS resource set, or wherein the maximum rank for the single TRP is equal to or less than a lesser quantity of either a default rank or a combination of the maximum rank associated with the first SRS resource set and the maximum rank associated with the second SRS resource set.

Aspect 24: The method of Aspect 22 or 23, wherein the quantity of ports for the single TRP is equal to or less than a quantity of ports for the first SRS resource set or a quantity of ports for the second SRS resource set, or wherein the quantity of ports for the single TRP is equal to or less than a lesser quantity of either a default quantity of ports or a combination of the quantity of ports for the first SRS resource set and the quantity of ports for the second SRS resource set.

Aspect 25: The method of one or more of Aspects 15-24, wherein an overall quantity of bits included in the DCI for the first TPMI field and the second TPMI field, for supporting dynamic switching between single transmit receive point (sTRP) communication and multiple transmit receive point (mTRP) communication, corresponds to a greater quantity of a first quantity of bits for sTRP communication or a second quantity of bits for mTRP communication.

Aspect 26: An apparatus for wireless communication at a device, comprising a processor; memory coupled with the processor; and instructions stored in the memory and executable by the processor to cause the apparatus to perform the method of one or more of Aspects 1-25.

Aspect 27: A device for wireless communication, comprising a memory and one or more processors coupled to the memory, the one or more processors configured to perform the method of one or more of Aspects 1-14.

Aspect 28: An apparatus for wireless communication, comprising at least one means for performing the method of one or more of Aspects 1-14.

Aspect 29: A non-transitory computer-readable medium storing code for wireless communication, the code comprising instructions executable by a processor to perform the method of one or more of Aspects 1-14.

Aspect 30: A non-transitory computer-readable medium storing a set of instructions for wireless communication, the set of instructions comprising one or more instructions that, when executed by one or more processors of a device, cause the device to perform the method of one or more of Aspects 1-14.

Aspect 31: An apparatus for wireless communication at a device, comprising a processor; memory coupled with the processor; and instructions stored in the memory and executable by the processor to cause the apparatus to perform the method of one or more of Aspects 1-25.

Aspect 32: A device for wireless communication, comprising a memory and one or more processors coupled to the memory, the one or more processors configured to perform the method of one or more of Aspects 15-25.

Aspect 33: An apparatus for wireless communication, comprising at least one means for performing the method of one or more of Aspects 15-25.

Aspect 34: A non-transitory computer-readable medium storing code for wireless communication, the code comprising instructions executable by a processor to perform the method of one or more of Aspects 15-25.

Aspect 35: A non-transitory computer-readable medium storing a set of instructions for wireless communication, the set of instructions comprising one or more instructions that, when executed by one or more processors of a device, cause the device to perform the method of one or more of Aspects 15-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, since those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A user equipment (UE) for wireless communication, comprising:
at least one processor; and
at least one memory communicatively coupled with the at least one processor and storing processor-readable code that, when executed by the at least one processor, is configured to cause the UE to:
receive configuration information associated with a first sounding reference signal (SRS) resource set and a second SRS resource set; and
receive downlink control information (DCI) that schedules a spatial division multiplexing (SDM) physical uplink shared channel (PUSCH) communication, the DCI including:
a first SRS resource indicator (SRI) field associated with the first SRS resource set that indicates one or more first transmission parameters for one or more first layers of the SDM PUSCH communication,
a first transmit precoder matrix indicator (TPMI) field that indicates one or more first precoding parameters for the one or more first layers,
a second SRI field associated with the second SRS resource set that indicates a one or more second transmission parameters for one or more second layers of the SDM PUSCH communication, and
a second TPMI field that indicates one or more second precoding parameters for the one or more second layers.

2. The UE of claim 1, wherein the one or more first transmission parameters comprise at least one of: one or more beams for the one or more first layers or one or more power control parameters for the one or more first layers, and wherein the one or more first precoding parameters comprise at least one of: a codebook-based precoder index or a quantity of layers for the one or more first layers.

3. The UE of claim 1, wherein the at least one memory further stores processor-readable code configured to cause the UE to identify a precoder matrix, for precoding the one or more first layers, based at least in part on a maximum rank associated with the first SRS resource set and a quantity of ports associated with an SRS resource, of the first SRS resource set, indicated by the first SRI field.

4. The UE of claim 3, wherein the at least one memory further stores processor-readable code configured to cause the UE to identify the maximum rank associated with the first SRS resource set based at least in part on at least one of: a radio resource control (RRC) configuration, a configuration at the UE, or a combined maximum rank for the first SRS resource set and the second SRS resource set.

5. The UE of claim 3, wherein, to cause the UE to identify the precoder matrix, the processor-readable code, when executed by the at least one processor, is configured to cause the UE to:
identify a first table based at least in part on the maximum rank and the quantity of antenna ports,
identify a TPMI index and a quantity of layers based at least in part on an association in the first table between the TPMI index, the quantity of layers, and a bit field index indicated by the first TPMI field,
identify a second table based at least in part on the quantity of layers and the quantity of ports, and
identify the precoder matrix in the second table based at least in part on the TPMI index.

6. The UE of claim 1, wherein a quantity of bits included in the first TPMI field is based at least in part on at least one of: a maximum rank associated with the first SRS resource set, a first quantity of one or more first ports associated with a first SRS resource of the first SRS resource set indicated by the first SRI field, a coherency of the one or more first ports associated with the first SRS resource and one or more second ports associated with a second SRS resource of the second SRS resource set indicated by the second SRI field, or whether fullpowerMode1 is configured.

7. The UE of claim 6, wherein the quantity of the one or more first ports and a quantity of the one or more second ports are a same quantity.

8. The UE of claim 6, wherein the quantity of the one or more first ports and a quantity of the one or more second ports are different quantities.

9. The UE of claim 6, wherein the quantity of bits included in the first TPMI field is based at least in part on a first maximum quantity of ports for the first SRS resource set, and wherein the quantity of bits included in the second TPMI field is based at least in part on a second maximum quantity of ports for the second SRS resource set with zero padding.

10. The UE of claim 1, wherein the DCI includes a dynamic switching indicator field that indicates that the first SRI field, the second SRI field, the first TPMI field, and the second TPMI field are associated with a single transmit receive point (TRP), wherein the one or more first transmission parameters and the one or more second transmission parameters are a same one or more transmission parameters, the same one or more transmission parameters being indicated in the DCI by a joint SRI field that includes the first SRI field and the second SRI field, and wherein the one or more first precoding parameters and the one or more second precoding parameters are a same one or more precoding parameters, the same one or more precoding parameters being indicated in the DCI by a joint TPMI field including the first TPMI field and the second TPMI field.

11. The UE of claim 10, wherein a quantity of bits included in the joint TPMI field is based at least in part on a maximum rank for the single TRP and a quantity of ports for the single TRP.

12. The UE of claim 11, wherein the maximum rank for the single TRP is equal to or less than a maximum rank associated with the first SRS resource set or a maximum rank associated with the second SRS resource set, or wherein the maximum rank for the single TRP is equal to or less than a lesser quantity of either a default rank or a combination of the maximum rank associated with the first SRS resource set and the maximum rank associated with the second SRS resource set.

13. The UE of claim 11, wherein the quantity of ports for the single TRP is equal to or less than a quantity of ports for the first SRS resource set or a quantity of ports for the second SRS resource set, or wherein the quantity of ports for the single TRP is equal to or less than a lesser quantity of either a default quantity of ports or a combination of the quantity of ports for the first SRS resource set and the quantity of ports for the second SRS resource set.

14. The UE of claim 1, wherein an overall quantity of bits included in the DCI for the first TPMI field and the second TPMI field, for supporting dynamic switching between single transmit receive point (sTRP) communication and multiple transmit receive point (mTRP) communication, corresponds to a greater quantity of a first quantity of bits for sTRP communication or a second quantity of bits for mTRP communication.

15. A base station for wireless communication, comprising:
at least one processor; and
at least one memory communicatively coupled with the at least one processor and storing processor-readable code that, when executed by the at least one processor, is configured to cause the base station to:
transmit configuration information associated with a first sounding reference signal (SRS) resource set and a second SRS resource set; and
transmit downlink control information (DCI) that schedules a spatial division multiplexing (SDM) physical uplink shared channel (PUSCH) communication, the DCI including:
a first SRS resource indicator (SRI) field associated with the first SRS resource set that indicates one or more first transmission parameters for one or more first layers of the SDM PUSCH communication,
a first transmit precoder matrix indicator (TPMI) field indicating one or more first precoding parameters for the one or more first layers,
a second SRI field associated with the second SRS resource set that indicates one or more second transmission parameters for one or more second layers of the SDM PUSCH communication, and
a second TPMI field indicating one or more second precoding parameters for the one or second more layers.

16. The base station of claim 15, wherein the one or more first transmission parameters comprise at least one of: one or more beams for the one or more first layers or one or more power control parameters for the one or more first layers, and wherein the one or more first precoding parameters comprise at least one of: a codebook-based precoder index or a quantity of layers for the one or more first layers.

17. The base station of claim 15, wherein a quantity of bits included in the first TPMI field is based at least in part on at least one of: a maximum rank associated with the first SRS resource set, a first quantity of one or more first ports associated with a first SRS resource of the first SRS resource set indicated by the first SRI field, a coherency of the one or more first ports associated with the first SRS resource and one or more second ports associated with a second SRS resource of the second SRS resource set indicated by the second SRI field, or whether fullpowerMode1 is configured.

18. The base station of claim 17, wherein the quantity of the one or more first ports and a quantity of the one or more second ports are a same quantity.

19. The base station of claim 17, wherein the quantity of the one or more first ports and a quantity of the one or more second ports are different quantities.

20. The base station of claim 17, wherein the quantity of bits included in the first TPMI field is based at least in part on a first maximum quantity of ports for the first SRS resource set, and wherein the quantity of bits included in the second TPMI field is based at least in part on a second maximum quantity of ports for the second SRS resource set with zero padding.

21. The base station of claim 15, wherein the DCI includes a dynamic switching indicator field that indicates that the first SRI field, the second SRI field, the first TPMI field, and the second TPMI field are associated with a single transmit receive point (TRP), wherein the one or more first transmission parameters and the one or more second transmission parameters are a same one or more transmission parameters, the same one or more transmission parameters being indicated in the DCI by a joint SRI field including the first SRI field and the second SRI field, and wherein the one or more first precoding parameters and the one or more second precoding parameters are a same one or more precoding parameters, the same one or more precoding parameters being indicated in the DCI by a joint TPMI field including the first TPMI field and the second TPMI field.

22. The base station of claim 21, wherein a quantity of bits included in the joint TPMI field is based at least in part on a maximum rank for the single TRP and a quantity of ports for the single TRP.

23. The base station of claim 22, wherein the maximum rank for the single TRP is equal to or less than a maximum rank associated with the first SRS resource set or a maximum rank associated with the second SRS resource set, or wherein the maximum rank for the single TRP is equal to or less than a lesser quantity of either a default rank or a combination of the maximum rank associated with the first SRS resource set and the maximum rank associated with the second SRS resource set.

24. The base station of claim 22, wherein the quantity of ports for the single TRP is equal to or less than a quantity of ports for the first SRS resource set or a quantity of ports for the second SRS resource set, or wherein the quantity of ports for the single TRP is equal to or less than a lesser quantity of either a default quantity of ports or a combination of the quantity of ports for the first SRS resource set and the quantity of ports for the second SRS resource set.

25. The base station of claim 15, wherein an overall quantity of bits included in the DCI for the first TPMI field and the second TPMI field, for supporting dynamic switching between single transmit receive point (sTRP) communication and multiple transmit receive point (mTRP) communication, corresponds to a greater quantity of a first quantity of bits for sTRP communication or a second quantity of bits for mTRP communication.

26. A method of wireless communication performed by a user equipment (UE), comprising:
receiving configuration information associated with a first sounding reference signal (SRS) resource set and a second SRS resource set; and
receiving downlink control information (DCI) that schedules a spatial division multiplexing (SDM) physical uplink shared channel (PUSCH) communication, the DCI including:
a first SRS resource indicator (SRI) field associated with the first SRS resource set that indicates one or more first transmission parameters for one or more first layers of the SDM PUSCH communication,
a first transmit precoder matrix indicator (TPMI) field that indicates one or more first precoding parameters for the one or more first layers,
a second SRI field associated with the second SRS resource set that indicates a one or more second transmission parameters for one or more second layers of the SDM PUSCH communication, and
a second TPMI field that indicates one or more second precoding parameters for the one or more second layers.

27. The method of claim 26, wherein the DCI includes a dynamic switching indicator field that indicates that the first SRI field, the second SRI field, the first TPMI field, and the second TPMI field are associated with a single transmit receive point (TRP), wherein the one or more first transmission parameters and the one or more second transmission parameters are a same one or more transmission parameters, the same one or more transmission parameters being indicated in the DCI by a joint SRI field that includes the first SRI field and the second SRI field, and wherein the one or more first precoding parameters and the one or more second precoding parameters are a same one or more precoding parameters, the same one or more precoding parameters being indicated in the DCI by a joint TPMI field including the first TPMI field and the second TPMI field.

28. The method of claim 26, wherein an overall quantity of bits included in the DCI for the first TPMI field and the second TPMI field, for supporting dynamic switching between single transmit receive point (sTRP) communication and multiple transmit receive point (mTRP) communication, corresponds to a greater quantity of a first quantity of bits for sTRP communication or a second quantity of bits for mTRP communication.

29. A method of wireless communication performed by a base station, comprising:
transmitting configuration information associated with a first sounding reference signal (SRS) resource set and a second SRS resource set; and
transmitting downlink control information (DCI) that schedules a spatial division multiplexing (SDM) physical uplink shared channel (PUSCH) communication, the DCI including:
a first SRS resource indicator (SRI) field associated with the first SRS resource set that indicates one or more first transmission parameters for one or more first layers of the SDM PUSCH communication,
a first transmit precoder matrix indicator (TPMI) field indicating one or more first precoding parameters for the one or more first layers,
a second SRI field associated with the second SRS resource set that indicates one or more second transmission parameters for one or more second layers of the SDM PUSCH communication, and
a second TPMI field indicating one or more second precoding parameters for the one or second more layers.

30. The method of claim 29, wherein the DCI includes a dynamic switching indicator field that indicates that the first SRI field, the second SRI field, the first TPMI field, and the second TPMI field are associated with a single transmit receive point (TRP), wherein the one or more first transmission parameters and the one or more second transmission parameters are a same one or more transmission parameters, the same one or more transmission parameters being indicated in the DCI by a joint SRI field including the first SRI field and the second SRI field, and wherein the one or more first precoding parameters and the one or more second precoding parameters are a same one or more precoding parameters, the same one or more precoding parameters being indicated in the DCI by a joint TPMI field including the first TPMI field and the second TPMI field.
